(19) United States
(12) Patent Application Publication
(10) Pub. No.: US 2024/0233268 A9
(43) Pub. Date: Jul. 11, 2024

(54) VIRTUAL REPRESENTATION ENCODING IN SCENE DESCRIPTIONS

(71) Applicant: QUALCOMM Incorporated, San Diego, CA (US)

(72) Inventors: Imed BOUAZIZI, Frisco, TX (US); Michel Adib SARKIS, San Diego, CA (US); Thomas STOCKHAMMER, Bergen (DE)

(21) Appl. No.: 18/486,414

(22) Filed: Oct. 13, 2023

Related U.S. Application Data
(60) Provisional application No. 63/380,210, filed on Oct. 19, 2022.

(51) Int. Cl. G06T 17/20

(52) U.S. Cl. CPC G06T 17/20

(57) ABSTRACT

Systems and techniques are described herein for generating virtual representation (e.g., avatar). For example, a process can include obtaining data describing a virtual representation, the data including a hierarchical set of nodes, wherein a first node of the set of nodes includes type information, source information, and a mapping, and wherein a child node of the hierarchical set of nodes includes data associated with a segment of the virtual representation; identifying, based on the type information, a format associated with the virtual representation of a user; identifying, based on the mapping, the child node in the hierarchical set of nodes; identifying, based on the source information, a portion of the data associated with the child node; and processing the data associated with the segment of the virtual representation of the child node based on a corresponding format for the virtual representation to generate a segment of the virtual representation.

### CROSS-REFERENCE TO RELATED APPLICATIONS

This application claims the benefit of U.S. Provisional Application No. 63/380,210, filed Oct. 19, 2022, which is hereby incorporated by reference, in its entirety and for all purposes.

### TECHNICAL FIELD

The present disclosure generally relates to virtual content for virtual environments or partially virtual environments. For example, aspects of the present disclosure include systems and techniques for providing virtual representation (e.g., avatar) encoding in scene description.

### BACKGROUND

An extended reality (XR) (e.g., virtual reality, augmented reality, mixed reality) system can provide a user with a virtual experience by immersing the user in a completely virtual environment (made up of virtual content) and/or can provide the user with an augmented or mixed reality experience by combining a real-world or physical environment with a virtual environment.

One example use case for XR content that provides virtual, augmented, or mixed reality to users is to present a user with a “metaverse” experience. The metaverse is essentially a virtual universe that includes one or more three-dimensional (3D) virtual worlds. For example, a metaverse virtual environment may allow a user to virtually interact with other users (e.g., in a social setting, in a virtual meeting, etc.), to virtually shop for goods, services, property, or other item, to play computer games, and/or to experience other services.

In some cases, a user may be represented in a virtual environment (e.g., a metaverse virtual environment) as a virtual representation of the user, sometimes referred to as an avatar. In any virtual environment, it is important for a system to generate high-quality avatars representing a person in a highly efficient and low-latency manner.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In one illustrative example, a method for generating a virtual representation of a user is provided. The method includes: obtaining information describing a virtual representation of the user, the information including a hierarchical set of nodes, wherein a first node of the hierarchical set of nodes comprises a root node for the hierarchical set of nodes, wherein the first node includes a mapping configuration for mapping child nodes of the hierarchical set of nodes to segments of the virtual representation of the user, and wherein a child node of the hierarchical set of nodes includes data associated with a segment of the virtual representation of the user; identifying a portion of the data associated with the child node; and processing the portion of the data associated with the child node to generate the segment of the virtual representation of the user.

As another example, an apparatus for generating a virtual representation of the user is provided. The apparatus includes at least one memory and at least one processor coupled to the at least one memory. The at least one processor is configured to: obtain information describing a virtual representation of the user, the information including a hierarchical set of nodes, wherein a first node of the hierarchical set of nodes comprises a root node for the hierarchical set of nodes, wherein the first node includes a mapping configuration for mapping child nodes of the hierarchical set of nodes to segments of the virtual representation of the user, and wherein a child node of the hierarchical set of nodes includes data associated with a segment of the virtual representation of the user; identify a portion of the data associated with the child node; and process the portion of the data associated with the child node to generate the segment of the virtual representation of the user.

In another example, a non-transitory computer-readable medium is provided. The non-transitory computer-readable medium has stored thereon instructions that, when executed by at least one processor, cause the at least one processor to: obtain information describing a virtual representation of the user, the information including a hierarchical set of nodes, wherein a first node of the hierarchical set of nodes comprises a root node for the hierarchical set of nodes, wherein the first node includes a mapping configuration for mapping child nodes of the hierarchical set of nodes to segments of the virtual representation of the user, and wherein a child node of the hierarchical set of nodes includes data associated with a segment of the virtual representation of the user; identify a portion of the data associated with the child node; and process the portion of the data associated with the child node to generate the segment of the virtual representation of the user.

As another example, an apparatus for generating a virtual representation is provided. The apparatus includes: means for obtaining information describing a virtual representation of the user, the information including a hierarchical set of nodes, wherein a first node of the hierarchical set of nodes comprises a root node for the hierarchical set of nodes, wherein the first node includes a mapping configuration for mapping child nodes of the hierarchical set of nodes to segments of the virtual representation of the user, and wherein a child node of the hierarchical set of nodes includes data associated with a segment of the virtual representation of the user; means for identifying a portion of the data associated with the child node; and means for processing the portion of the data associated with the child node to generate the segment of the virtual representation of the user.

In some aspects, one or more of the apparatuses described herein is, is part of, and/or includes an extended reality (XR) device or system (e.g., a virtual reality (VR) device, an augmented reality (AR) device, or a mixed reality (MR) device), a mobile device (e.g., a mobile telephone or other mobile device), a wearable device, a wireless communication device, a camera, a personal computer, a laptop computer, a vehicle or a computing device or component of a vehicle, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating an example of an extended reality (XR) system, according to aspects of the disclosure;

FIG. 2 is a diagram illustrating an example of a three-dimensional (3D) collaborative

virtual environment, according to aspects of the disclosure;

FIG. 3 is an image with a virtual representation (an avatar) of a user, according to aspects of the disclosure;

FIG. 4 is a diagram illustrating another example of an XR system, according to aspects of the disclosure;

FIG. 5 is a diagram illustrating an example configuration of a client device, according to aspects of the disclosure;

FIG. 6 is a diagram illustrating an example of a normal map, an albedo map, and a specular reflection map, according to aspects of the disclosure;

FIG. 7 is a diagram illustrating an example of one technique for performing avatar animation, according to aspects of the disclosure;

FIG. 8 is a diagram illustrating an example of performing facial animation with blendshapes, according to aspects of the disclosure;

FIG. 9 is a diagram illustrating an example of a system that can generate a 3D Morphable Model (3DMM) face mesh, according to aspects of the disclosure;

FIG. 10 is a diagram illustrating an example of animating an avatar, according to aspects of the disclosure;

FIG. 11 is a diagram illustrating an example of using a 3DMM fitting curve to drive a virtual representation (or avatar) with a metahuman, according to aspects of the disclosure;

FIG. 12 is a diagram illustrating an example of an end-to-end flow of a system, according to aspects of the disclosure;

FIG. 13 is a diagram illustrating an example of performing avatar animation,

according to aspects of the disclosure;

FIG. 14 is a diagram illustrating an example of an example of an XR system configured with an avatar call flow directly between client devices, in accordance with aspects of the present disclosure;

FIG. 15 is a diagram illustrating an example of an example of an XR system configured with an avatar call flow directly between client devices, in accordance with aspects of the present disclosure;

FIG. 16 is a block diagram illustrating an example of a virtual representation (or avatar) reconstruction system or pipeline, in accordance with aspects of the present disclosure;

FIG. 17 is a diagram illustrating a structure of a virtual representation (or avatar) in Graphics Language Transmission Format (glTF), according to aspects of the disclosure;

FIG. 18 is an example of a JavaScript Object Notation (JSON) schema for the systems and techniques described herein, in accordance with some examples;

FIG. 19 is a flow diagram illustrating a process for generating virtual content in a distributed system, in accordance with aspects of the present disclosure; and

FIG. 20 is a diagram illustrating an example of a computing system, according to aspects of the disclosure.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

As noted previously, an extended reality (XR) system or device can provide a user with an XR experience by presenting virtual content to the user (e.g., for a completely immersive experience) and/or can combine a view of a real-world or physical environment with a display of a virtual environment (made up of virtual content). The real-world environment can include real-world objects (also referred to as physical objects), such as people, vehicles, buildings, tables, chairs, and/or other real-world or physical objects. As used herein, the terms XR system and XR device are used interchangeably. Examples of XR systems or devices include head-mounted displays (HMDs), smart glasses (e.g., AR glasses, MR glasses, etc.), among others.

XR systems can include virtual reality (VR) systems facilitating interactions with VR environments, augmented reality (AR) systems facilitating interactions with AR environments, mixed reality (MR) systems facilitating interactions with MR environments, and/or other XR systems. For instance, VR provides a complete immersive experience in a three-dimensional (3D) computer-generated VR environment or video depicting a virtual version of a real-world environment. VR content can include VR video in some cases, which can be captured and rendered at very high quality, potentially providing a truly immersive virtual reality experience. Virtual reality applications can include gaming, training, education, sports video, online shopping, among others. VR content can be rendered and displayed using a VR system or device, such as a VR HMD or other VR headset, which fully covers a user's eyes during a VR experience.

AR is a technology that provides virtual or computer-generated content (referred to as AR content) over the user's view of a physical, real-world scene or environment. AR content can include any virtual content, such as video, images, graphic content, location data (e.g., global positioning system (GPS) data or other location data), sounds, any combination thereof, and/or other augmented content. An AR system is designed to enhance (or augment), rather than to replace, a person's current perception of reality. For example, a user can see a real stationary or moving physical object through an AR device display, but the user's visual perception of the physical object may be augmented or enhanced by a virtual image of that object (e.g., a real-world car replaced by a virtual image of a DeLorean), by AR content added to the physical object (e.g., virtual wings added to a live animal), by AR content displayed relative to the physical object (e.g., informational virtual content displayed near a sign on a building, a virtual coffee cup virtually anchored to (e.g., placed on top of) a real-world table in one or more images, etc.), and/or by displaying other types of AR content. Various types of AR systems can be used for gaming, entertainment, and/or other applications.

MR technologies can combine aspects of VR and AR to provide an immersive experience for a user. For example, in an MR environment, real-world and computer-generated objects can interact (e.g., a real person can interact with a virtual person as if the virtual person were a real person).

An XR environment can be interacted with in a seemingly real or physical way. As a user experiencing an XR environment (e.g., an immersive VR environment) moves in the real world, rendered virtual content (e.g., images rendered in a virtual environment in a VR experience) also changes, giving the user the perception that the user is moving within the XR environment. For example, a user can turn left or right, look up or down, and/or move forwards or backwards, thus changing the user's point of view of the XR environment. The XR content presented to the user can change accordingly, so that the user's experience in the XR environment is as seamless as it would be in the real world.

In some cases, an XR system can match the relative pose and movement of objects and devices in the physical world. For example, an XR system can use tracking information to calculate the relative pose of devices, objects, and/or features of the real-world environment in order to match the relative position and movement of the devices, objects, and/or the real-world environment. In some examples, the XR system can use the pose and movement of one or more devices, objects, and/or the real-world environment to render content relative to the real-world environment in a convincing manner. The relative pose information can be used to match virtual content with the user's perceived motion and the spatio-temporal state of the devices, objects, and real-world environment. In some cases, an XR system can track parts of the user (e.g., a hand and/or fingertips of a user) to allow the user to interact with items of virtual content.

XR systems or devices can facilitate interaction with different types of XR environments (e.g., a user can use an XR system or device to interact with an XR environment). One example of an XR environment is a metaverse virtual environment. A user may virtually interact with other users (e.g., in a social setting, in a virtual meeting, etc.), virtually shop for items (e.g., goods, services, property, etc.), to play computer games, and/or to experience other services in a metaverse virtual environment. In one illustrative example, an XR system may provide a 3D collaborative virtual environment for a group of users. The users may interact with one another via virtual representations of the users in the virtual environment. The users may visually, audibly, haptically, or otherwise experience the virtual environment while interacting with virtual representations of the other users.

A virtual representation of a user may be used to represent the user in a virtual environment. A virtual representation of a user is also referred to herein as an avatar. An avatar representing a user may mimic an appearance, movement, mannerisms, and/or other features of the user. A virtual representation (or avatar) may be generated/animated on real-time based on captured input from users devices. Avatars may range from basic synthetic 3D representations to more realistic representations of the user. In some examples, the user may desire that the avatar representing the person in the virtual environment appear as a digital twin of the user. In any virtual environment, it is important for an XR system to efficiently generate high-quality avatars (e.g., realistically representing the appearance, movement, etc. of the person) in a low-latency manner. It can also be important for the XR system to render audio in an effective manner to enhance the XR experience.

For instance, in the example of the 3D collaborative virtual environment from above, an XR system of a user from the group of users may display virtual representations (or avatars) of the other users sitting at specific locations at a virtual table or in a virtual room. The virtual representations of the users and the background of the virtual environment should be displayed in a realistic manner (e.g., as if the users were sitting together in the real world). The heads, bodies, arms, and hands of the users can be animated as the users move in the real world. Audio may need to be spatially rendered or may be rendered monophonically. Latency in rendering and animating the virtual representations should be minimal in order to maintain a high-quality user experience.

The computational complexity of generating virtual environments by XR systems can impose significant power and resource demands, which can be a limiting factor in implementing XR experiences (e.g., reducing the ability of XR devices to efficiently generate and animate virtual content in a low-latency manner). For example, the computational complexity of rendering and animating virtual representations of users and composing a virtual scene can impose large power and resource demands on devices when implementing XR applications. Such power and resource demands are exacerbated by recent trends towards implementing such technologies in mobile and wearable devices (e.g., HMDs, XR glasses, etc.), and making such devices smaller, lighter, and more comfortable (e.g., by reducing the heat emitted by the device) to wear by the user for longer periods of time. In view of such factors, it may be difficult for an XR device (e.g., an HMD) of a user to render and animate virtual representations of other users and to compose a scene and generate a target view of a virtual environment for display to the user of the XR device.

Furthermore, there are different ways to represent an avatar and corresponding animation data, in which case it can be difficult to integrate every single variant of these representations into a scene description. The scene description is a file or document that includes information describing or defining a 3D scene.

Systems, apparatuses, electronic devices, methods (also referred to as processes), and computer-readable media (collectively referred to herein as “systems and techniques”) are described herein for providing virtual representation (e.g., avatar) encoding in scene descriptions. The systems and techniques can decouple the representation of a virtual representation (or avatar) and its animation data from the avatar integration in the scene description. For example, a virtual representation (or avatar) reconstruction step can be tailored to a virtual representation (or avatar) of a user, which can be identified through a field (e.g., a type Uniform Resource Name (URN) field, such as defined in RFC8141), and can be used to create a dynamic mesh that represents the virtual representation (or avatar) of the user. Such a solution can allow the systems and techniques to break down the virtual representation (or avatar) into multiple mesh nodes, where each mesh node corresponds to a body part of the virtual representation (or avatar). The multiple mesh nodes enable an XR system to support interactivity with various parts of a virtual representation (e.g., with hands of the avatar).

Various aspects of the application will be described with respect to the figures.

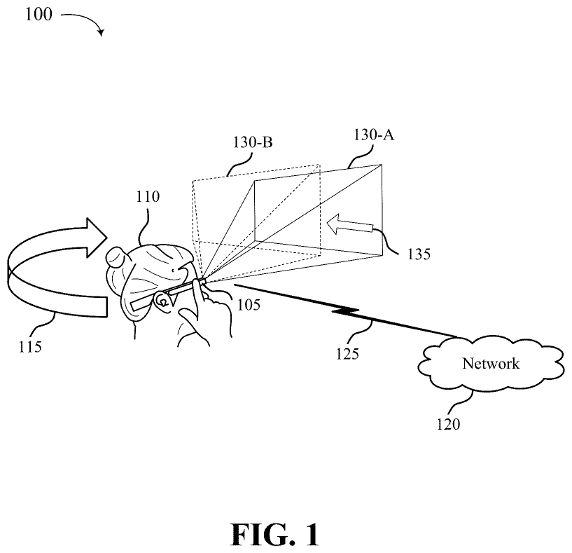

FIG. 1 illustrates an example of an extended reality system 100. As shown, the extended reality system 100 includes a device 105, a network 120, and a communication link 125. In some cases, the device 105 may be an extended reality (XR) device, which may generally implement aspects of extended reality, including virtual reality (VR), augmented reality (AR), mixed reality (MR), etc. Systems including a device 105, a network 120, or other elements in extended reality system 100 may be referred to as extended reality systems.

The device 105 may overlay virtual objects with real-world objects in a view 130. For example, the view 130 may generally refer to visual input to a user 110 via the device 105, a display generated by the device 105, a configuration of virtual objects generated by the device 105, etc. For example, view 130-A may refer to visible real-world objects (also referred to as physical objects) and visible virtual objects, overlaid on or coexisting with the real-world objects, at some initial time. View 130-B may refer to visible real-world objects and visible virtual objects, overlaid on or coexisting with the real-world objects, at some later time. Positional differences in real-world objects (e.g., and thus overlaid virtual objects) may arise from view 130-A shifting to view 130-B at 135 due to head motion 115. In another example, view 130-A may refer to a completely virtual environment or scene at the initial time and view 130-B may refer to the virtual environment or scene at the later time.

Generally, device 105 may generate, display, project, etc. virtual objects and/or a virtual environment to be viewed by a user 110 (e.g., where virtual objects and/or a portion of the virtual environment may be displayed based on user 110 head pose prediction in accordance with the techniques described herein). In some examples, the device 105 may include a transparent surface (e.g., optical glass) such that virtual objects may be displayed on the transparent surface to overlay virtual objects on real word objects viewed through the transparent surface. Additionally or alternatively, the device 105 may project virtual objects onto the real-world environment. In some cases, the device 105 may include a camera and may display both real-world objects (e.g., as frames or images captured by the camera) and virtual objects overlaid on displayed real-world objects. In various examples, device 105 may include aspects of a virtual reality headset, smart glasses, a live feed video camera, a GPU, one or more sensors (e.g., such as one or more IMUs, image sensors, microphones, etc.), one or more output devices (e.g., such as speakers, display, smart glass, etc.), etc.

In some cases, head motion 115 may include user 110 head rotations, translational head movement, etc. The device 105 may update the view 130 of the user 110 according to the head motion 115. For example, the device 105 may display view 130-A for the user 110 before the head motion 115. In some cases, after the head motion 115, the device 105 may display view 130-B to the user 110. The extended reality system (e.g., device 105) may render or update the virtual objects and/or other portions of the virtual environment for display as the view 130-A shifts to view 130-B.

In some cases, the extended reality system 100 may provide various types of virtual experiences, such as a three-dimensional (3D) gaming experiences, social media experiences, collaborative virtual environment for a group of users (e.g., including the user 110), among others. While some examples provided herein apply to 3D collaborative virtual environments, the systems and techniques described herein apply to any type of virtual environment or experience in which a virtual representation (or avatar) can be used to represent a user or participant of the virtual environment/experience.

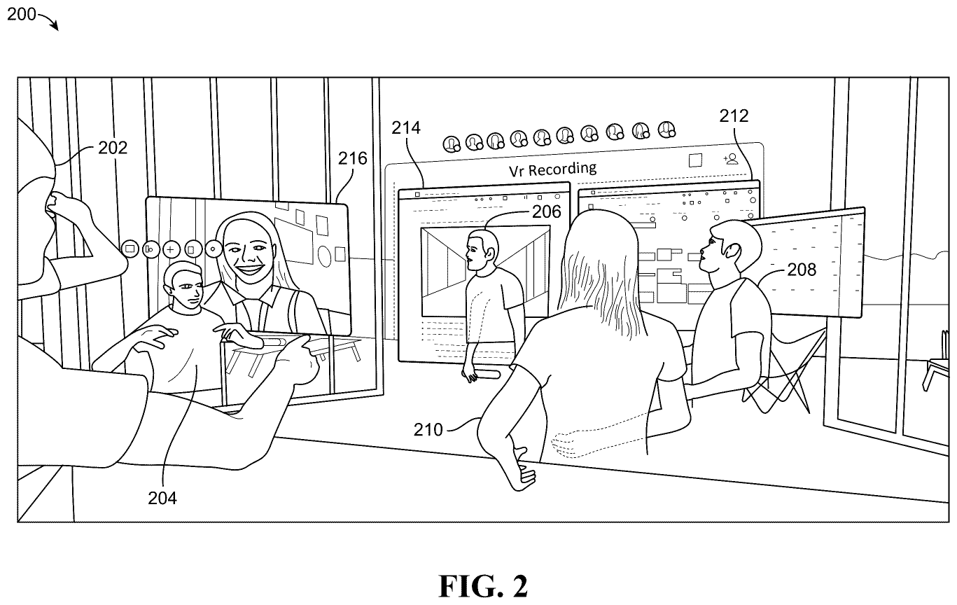

FIG. 2 is a diagram illustrating an example of a 3D collaborative virtual environment 200 in which various users interact with one another in a virtual session via virtual representations (or avatars) of the users in the virtual environment 200. The virtual representations include including a virtual representation 202 of a first user, a virtual representation 204 of a second user, a virtual representation 206 of a third user, a virtual representation 208 of a fourth user, and a virtual representation 210 of a fifth user. Other background information of the virtual environment 200 is also shown, including a virtual calendar 212, a virtual web page 214, and a virtual video conference interface 216. The users may visually, audibly, haptically, or otherwise experience the virtual environment from each user's perspective while interacting with the virtual representations of the other users. For example, the virtual environment 200 is shown from the perspective of the first user (represented by the virtual representation 202).

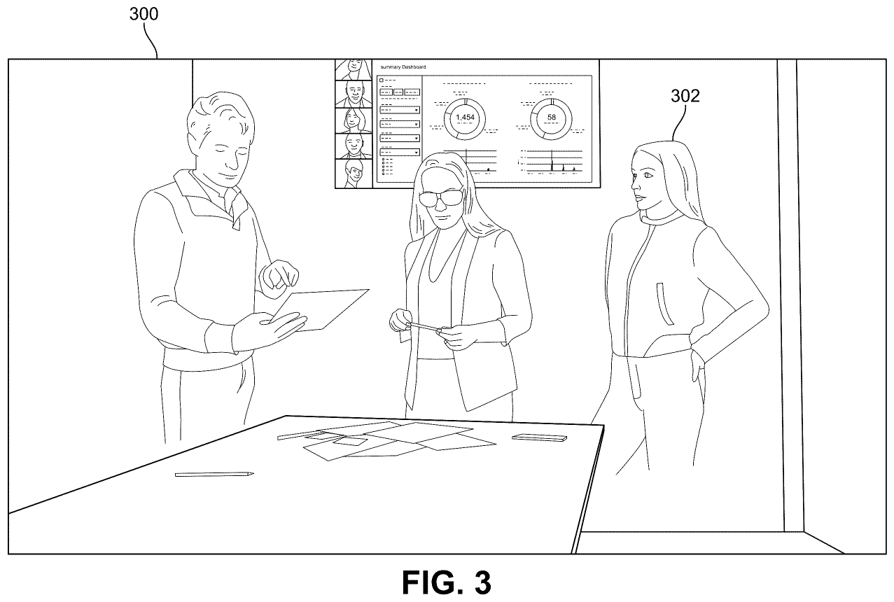

FIG. 3 is an image 300 illustrating an example of virtual representations of various users, including a virtual representation 302 of one of the users. For instance, the virtual representation 302 may be used in the 3D collaborative virtual environment 200 of FIG. 2.

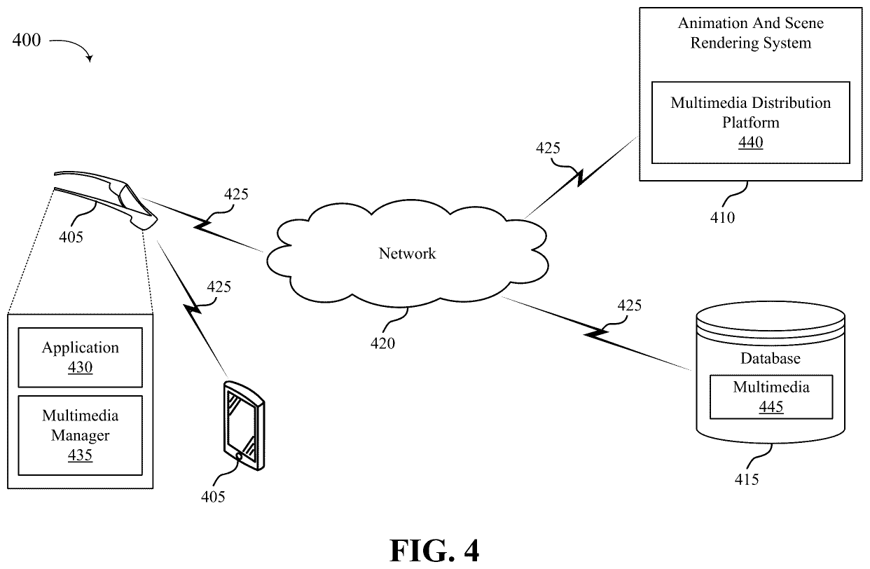

FIG. 4 is a diagram illustrating an example of a system 400 that can be used to perform the systems and techniques described herein, in accordance with aspects of the present disclosure. As shown, the system 400 includes client devices 405, an animation and scene rendering system 410, and storage 415. Although the system 400 illustrates two devices 405, a single animation and scene rendering system 410, a single storage 415, and a single network 420, the present disclosure applies to any system architecture having one or more devices 405, animation and scene rendering systems 410, storage 415, and networks 420. In some cases, the storage 415 may be part of the animation and scene rendering system 410. The devices 405, the animation and scene rendering system 410, and the storage 415 may communicate with each other and exchange information that supports generation of virtual content for XR, such as multimedia packets, multimedia data, multimedia control information, pose prediction parameters, via network 420 using communications links 425. In some cases, a portion of the techniques described herein for providing distributed generation of virtual content may be performed by one or more of the devices 405 and a portion of the techniques may be performed by the animation and scene rendering system 410, or both.

A device 405 may be an XR device (e.g., a head-mounted display (HMD), XR glasses such as virtual reality (VR) glasses, augmented reality (AR) glasses, etc.), a mobile device (e.g., a cellular phone, a smartphone, a personal digital assistant (PDA), etc.), a wireless communication device, a tablet computer, a laptop computer, and/or other device that supports various types of communication and functional features related to multimedia (e.g., transmitting, receiving, broadcasting, streaming, sinking, capturing, storing, and recording multimedia data). A device 405 may, additionally or alternatively, be referred to by those skilled in the art as a user equipment (UE), a user device, a smartphone, a Bluetooth device, a Wi-Fi device, a mobile station, a subscriber station, a mobile unit, a subscriber unit, a wireless unit, a remote unit, a mobile device, a wireless device, a wireless communications device, a remote device, an access terminal, a mobile terminal, a wireless terminal, a remote terminal, a handset, a user agent, a mobile client, a client, and/or some other suitable terminology. In some cases, the devices 405 may also be able to communicate directly with another device (e.g., using a peer-to-peer (P2P) or device-to-device (D2D) protocol, such as using sidelink communications). For example, a device 405 may be able to receive from or transmit to another device 405 variety of information, such as instructions or commands (e.g., multimedia-related information).

The devices 405 may include an application 430 and a multimedia manager 435. While the system 400 illustrates the devices 405 including both the application 430 and the multimedia manager 435, the application 430 and the multimedia manager 435 may be an optional feature for the devices 405. In some cases, the application 430 may be a multimedia-based application that can receive (e.g., download, stream, broadcast) from the animation and scene rendering systems 410, storage 415 or another device 405, or transmit (e.g., upload) multimedia data to the animation and scene rendering systems 410, the storage 415, or to another device 405 via using communications links 425.

The multimedia manager 435 may be part of a general-purpose processor, a digital signal processor (DSP), an image signal processor (ISP), a central processing unit (CPU), a graphics processing unit (GPU), a microcontroller, an application-specific integrated circuit (ASIC), a field-programmable gate array (FPGA), a discrete gate or transistor logic component, a discrete hardware component, or any combination thereof, or other programmable logic device, discrete gate or transistor logic, discrete hardware components, or any combination thereof designed to perform the functions described in the present disclosure, and/or the like. For example, the multimedia manager 435 may process multimedia (e.g., image data, video data, audio data) from and/or write multimedia data to a local memory of the device 405 or to the storage 415.

The multimedia manager 435 may also be configured to provide multimedia enhancements, multimedia restoration, multimedia analysis, multimedia compression, multimedia streaming, and multimedia synthesis, among other functionality. For example, the multimedia manager 435 may perform white balancing, cropping, scaling (e.g., multimedia compression), adjusting a resolution, multimedia stitching, color processing, multimedia filtering, spatial multimedia filtering, artifact removal, frame rate adjustments, multimedia encoding, multimedia decoding, and multimedia filtering. By further example, the multimedia manager 435 may process multimedia data to support server-based pose prediction for XR, according to the techniques described herein.

The animation and scene rendering system 410 may be a server device, such as a data server, a cloud server, a server associated with a multimedia subscription provider, proxy server, web server, application server, communications server, home server, mobile server, edge or cloud-based server, a personal computer acting as a server device, a mobile device such as a mobile phone acting as a server device, an XR device acting as a server device, a network router, any combination thereof, or other server device. The animation and scene rendering system 410 may in some cases include a multimedia distribution platform 440. In some cases, the multimedia distribution platform 440 may be a separate device or system from the animation and scene rendering system 410. The multimedia distribution platform 440 may allow the devices 405 to discover, browse, share, and download multimedia via network 420 using communications links 425, and therefore provide a digital distribution of the multimedia from the multimedia distribution platform 440. As such, a digital distribution may be a form of delivering media content such as audio, video, images, without the use of physical media but over online delivery mediums, such as the Internet. For example, the devices 405 may upload or download multimedia-related applications for streaming, downloading, uploading, processing, enhancing, etc. multimedia (e.g., images, audio, video). The animation and scene rendering system 410 or the multimedia distribution platform 440 may also transmit to the devices 405 a variety of information, such as instructions or commands (e.g., multimedia-related information) to download multimedia-related applications on the device 405.

The storage 415 may store a variety of information, such as instructions or commands (e.g., multimedia-related information). For example, the storage 415 may store multimedia 445, information from devices 405 (e.g., pose information, representation information for virtual representations or avatars of users, such as codes or features related to facial representations, body representations, hand representations, etc., and/or other information). A device 405 and/or the animation and scene rendering system 410 may retrieve the stored data from the storage 415 and/or more send data to the storage 415 via the network 420 using communication links 425. In some examples, the storage 415 may be a memory device (e.g., read only memory (ROM), random access memory (RAM), cache memory, buffer memory, etc.), a relational database (e.g., a relational database management system (RDBMS) or a Structured Query Language (SQL) database), a non-relational database, a network database, an object-oriented database, or other type of database, that stores the variety of information, such as instructions or commands (e.g., multimedia-related information).

The network 420 may provide encryption, access authorization, tracking, Internet Protocol (IP) connectivity, and other access, computation, modification, and/or functions. Examples of network 420 may include any combination of cloud networks, local area networks (LAN), wide area networks (WAN), virtual private networks (VPN), wireless networks (using 802.11, for example), cellular networks (using third generation (3G), fourth generation (4G), long-term evolved (LTE), or new radio (NR) systems (e.g., fifth generation (5G)), etc. Network 420 may include the Internet.

The communications links 425 shown in the system 400 may include uplink transmissions from the device 405 to the animation and scene rendering systems 410 and the storage 415, and/or downlink transmissions, from the animation and scene rendering systems 410 and the storage 415 to the device 405. The communications links 425 may transmit bidirectional communications and/or unidirectional communications. In some examples, the communication links 425 may be a wired connection or a wireless connection, or both. For example, the communications links 425 may include one or more connections, including but not limited to, Wi-Fi, Bluetooth, Bluetooth low-energy (BLE), cellular, Z-WAVE, 802.11, peer-to-peer, LAN, wireless local area network (WLAN), Ethernet, FireWire, fiber optic, and/or other connection types related to wireless communication systems.

In some aspects, a user of the device 405 (referred to as a first user) may be participating in a virtual session with one or more other users (including a second user of an additional device). In such examples, the animation and scene rendering systems 410 may process information received from the device 405 (e.g., received directly from the device 405, received from storage 415, etc.) to generate and/or animate a virtual representation (or avatar) for the first user. The animation and scene rendering systems 410 may compose a virtual scene that includes the virtual representation of the user and in some cases background virtual information from a perspective of the second user of the additional device. The animation and scene rendering systems 410 may transmit (e.g., via network 120) a frame of the virtual scene to the additional device. Further details regarding such aspects are provided below.

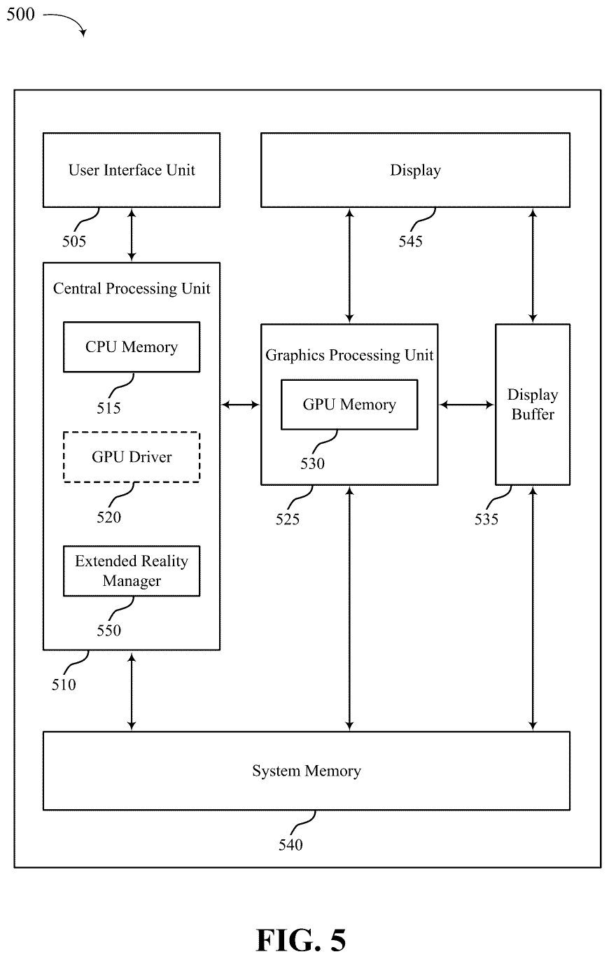

FIG. 5 is a diagram illustrating an example of a device 500. The device 500 can be implemented as a client device (e.g., device 405 of FIG. 4) or as an animation and scene rendering system (e.g., the animation and scene rendering system 410). As shown, the device 500 includes a central processing unit (CPU) 510 having CPU memory 515, a GPU 525 having GPU memory 530, a display 545, a display buffer 535 storing data associated with rendering, a user interface unit 505, and a system memory 540. For example, system memory 540 may store a GPU driver 520 (illustrated as being contained within CPU 510 as described below) having a compiler, a GPU program, a locally-compiled GPU program, and the like. User interface unit 505, CPU 510, GPU 525, system memory 540, display 545, and extended reality manager 550 may communicate with each other (e.g., using a system bus).

Examples of CPU 510 include, but are not limited to, a digital signal processor (DSP), general purpose microprocessor, application specific integrated circuit (ASIC), field programmable logic array (FPGA), or other equivalent integrated or discrete logic circuitry. Although CPU 510 and GPU 525 are illustrated as separate units in the example of FIG. 5, in some examples, CPU 510 and GPU 525 may be integrated into a single unit. CPU 510 may execute one or more software applications. Examples of the applications may include operating systems, word processors, web browsers, e-mail applications, spreadsheets, video games, audio and/or video capture, playback or editing applications, or other such applications that initiate the generation of image data to be presented via display 545. As illustrated, CPU 510 may include CPU memory 515. For example, CPU memory 515 may represent on-chip storage or memory used in executing machine or object code. CPU memory 515 may include one or more volatile or non-volatile memories or storage devices, such as flash memory, a magnetic data media, an optical storage media, etc. CPU 510 may be able to read values from or write values to CPU memory 515 more quickly than reading values from or writing values to system memory 540, which may be accessed, e.g., over a system bus.

GPU 525 may represent one or more dedicated processors for performing graphical operations. For example, GPU 525 may be a dedicated hardware unit having fixed function and programmable components for rendering graphics and executing GPU applications. GPU 525 may also include a DSP, a general purpose microprocessor, an ASIC, an FPGA, or other equivalent integrated or discrete logic circuitry. GPU 525 may be built with a highly-parallel structure that provides more efficient processing of complex graphic-related operations than CPU 510. For example, GPU 525 may include a plurality of processing elements that are configured to operate on multiple vertices or pixels in a parallel manner. The highly parallel nature of GPU 525 may allow GPU 525 to generate graphic images (e.g., graphical user interfaces and two-dimensional or three-dimensional graphics scenes) for display 545 more quickly than CPU 510.

GPU 525 may, in some instances, be integrated into a motherboard of device 500. In other instances, GPU 525 may be present on a graphics card or other device or component that is installed in a port in the motherboard of device 500 or may be otherwise incorporated within a peripheral device configured to interoperate with device 500. As illustrated, GPU 525 may include GPU memory 530. For example, GPU memory 530 may represent on-chip storage or memory used in executing machine or object code. GPU memory 530 may include one or more volatile or non-volatile memories or storage devices, such as flash memory, a magnetic data media, an optical storage media, etc. GPU 525 may be able to read values from or write values to GPU memory 530 more quickly than reading values from or writing values to system memory 540, which may be accessed, e.g., over a system bus. That is, GPU 525 may read data from and write data to GPU memory 530 without using the system bus to access off-chip memory. This operation may allow GPU 525 to operate in a more efficient manner by reducing the need for GPU 525 to read and write data via the system bus, which may experience heavy bus traffic.

Display 545 represents a unit capable of displaying video, images, text or any other type of data for consumption by a viewer. In some cases, such as when the device 500 is implemented as an animation and scene rendering system, the device 500 may not include the display 545. The display 545 may include a liquid-crystal display (LCD), a light emitting diode (LED) display, an organic LED (OLED), an active-matrix OLED (AMOLED), or the like. Display buffer 535 represents a memory or storage device dedicated to storing data for presentation of imagery, such as computer-generated graphics, still images, video frames, or the like for display 545. Display buffer 535 may represent a two-dimensional buffer that includes a plurality of storage locations. The number of storage locations within display buffer 535 may, in some cases, generally correspond to the number of pixels to be displayed on display 545. For example, if display 545 is configured to include 640×480 pixels, display buffer 535 may include 640×480 storage locations storing pixel color and intensity information, such as red, green, and blue pixel values, or other color values. Display buffer 535 may store the final pixel values for each of the pixels processed by GPU 525. Display 545 may retrieve the final pixel values from display buffer 535 and display the final image based on the pixel values stored in display buffer 535.

User interface unit 505 represents a unit with which a user may interact with or otherwise interface to communicate with other units of device 500, such as CPU 510. Examples of user interface unit 505 include, but are not limited to, a trackball, a mouse, a keyboard, and other types of input devices. User interface unit 505 may also be, or include, a touch screen and the touch screen may be incorporated as part of display 545.

System memory 540 may include one or more computer-readable storage media. Examples of system memory 540 include, but are not limited to, a random access memory (RAM), static RAM (SRAM), dynamic RAM (DRAM), a read-only memory (ROM), an electrically erasable programmable read-only memory (EEPROM), a compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor. System memory 540 may store program modules and/or instructions that are accessible for execution by CPU 510. Additionally, system memory 540 may store user applications and application surface data associated with the applications. System memory 540 may in some cases store information for use by and/or information generated by other components of device 500. For example, system memory 540 may act as a device memory for GPU 525 and may store data to be operated on by GPU 555 as well as data resulting from operations performed by GPU 525

In some examples, system memory 540 may include instructions that cause CPU 510 or GPU 525 to perform the functions ascribed to CPU 510 or GPU 525 in aspects of the present disclosure. System memory 540 may, in some examples, be considered as a non-transitory storage medium. The term “non-transitory” should not be interpreted to mean that system memory 540 is non-movable. As one example, system memory 540 may be removed from device 500 and moved to another device. As another example, a system memory substantially similar to system memory 540 may be inserted into device 500. In certain examples, a non-transitory storage medium may store data that can, over time, change (e.g., in RAM).

System memory 540 may store a GPU driver 520 and compiler, a GPU program, and a locally-compiled GPU program. The GPU driver 520 may represent a computer program or executable code that provides an interface to access GPU 525. CPU 510 may execute the GPU driver 520 or portions thereof to interface with GPU 525 and, for this reason, GPU driver 520 is shown in the example of FIG. 5 within CPU 510. GPU driver 520 may be accessible to programs or other executables executed by CPU 510, including the GPU program stored in system memory 540. Thus, when one of the software applications executing on CPU 510 requires graphics processing, CPU 510 may provide graphics commands and graphics data to GPU 525 for rendering to display 545 (e.g., via GPU driver 520).

In some cases, the GPU program may include code written in a high level (HL) programming language, e.g., using an application programming interface (API). Examples of APIs include Open Graphics Library (“OpenGL”), DirectX, Render-Man, WebGL, or any other public or proprietary standard graphics API. The instructions may also conform to so-called heterogeneous computing libraries, such as Open-Computing Language (“OpenCL”), DirectCompute, etc. In general, an API includes a predetermined, standardized set of commands that are executed by associated hardware. API commands allow a user to instruct hardware components of a GPU 525 to execute commands without user knowledge as to the specifics of the hardware components. In order to process the graphics rendering instructions, CPU 510 may issue one or more rendering commands to GPU 525 (e.g., through GPU driver 520) to cause GPU 525 to perform some or all of the rendering of the graphics data. In some examples, the graphics data to be rendered may include a list of graphics primitives (e.g., points, lines, triangles, quadrilaterals, etc.).

The GPU program stored in system memory 540 may invoke or otherwise include one or more functions provided by GPU driver 520. CPU 510 generally executes the program in which the GPU program is embedded and, upon encountering the GPU program, passes the GPU program to GPU driver 520. CPU 510 executes GPU driver 520 in this context to process the GPU program. That is, for example, GPU driver 520 may process the GPU program by compiling the GPU program into object or machine code executable by GPU 525. This object code may be referred to as a locally-compiled GPU program. In some examples, a compiler associated with GPU driver 520 may operate in real-time or near-real-time to compile the GPU program during the execution of the program in which the GPU program is embedded. For example, the compiler generally represents a unit that reduces HL instructions defined in accordance with a HL programming language to low-level (LL) instructions of a LL programming language. After compilation, these LL instructions are capable of being executed by specific types of processors or other types of hardware, such as FPGAs, ASICs, and the like (including, but not limited to, CPU 510 and GPU 525).

In the example of FIG. 5, the compiler may receive the GPU program from CPU 510 when executing HL code that includes the GPU program. That is, a software application being executed by CPU 510 may invoke GPU driver 520 (e.g., via a graphics API) to issue one or more commands to GPU 525 for rendering one or more graphics primitives into displayable graphics images. The compiler may compile the GPU program to generate the locally-compiled GPU program that conforms to a LL programming language. The compiler may then output the locally-compiled GPU program that includes the LL instructions. In some examples, the LL instructions may be provided to GPU 525 in the form a list of drawing primitives (e.g., triangles, rectangles, etc.).

The LL instructions (e.g., which may alternatively be referred to as primitive definitions) may include vertex specifications that specify one or more vertices associated with the primitives to be rendered. The vertex specifications may include positional coordinates for each vertex and, in some instances, other attributes associated with the vertex, such as color coordinates, normal vectors, and texture coordinates. The primitive definitions may include primitive type information, scaling information, rotation information, and the like. Based on the instructions issued by the software application (e.g., the program in which the GPU program is embedded), GPU driver 520 may formulate one or more commands that specify one or more operations for GPU 525 to perform in order to render the primitive. When GPU 525 receives a command from CPU 510, it may decode the command and configure one or more processing elements to perform the specified operation and may output the rendered data to display buffer 535.

GPU 525 may receive the locally-compiled GPU program, and then, in some instances, GPU 525 renders one or more images and outputs the rendered images to display buffer 535. For example, GPU 525 may generate a number of primitives to be displayed at display 545. Primitives may include one or more of a line (including curves, splines, etc.), a point, a circle, an ellipse, a polygon (e.g., a triangle), or any other two-dimensional primitive. The term “primitive” may also refer to three-dimensional primitives, such as cubes, cylinders, sphere, cone, pyramid, torus, or the like. Generally, the term “primitive” refers to any basic geometric shape or element capable of being rendered by GPU 525 for display as an image (or frame in the context of video data) via display 545. GPU 525 may transform primitives and other attributes (e.g., that define a color, texture, lighting, camera configuration, or other aspect) of the primitives into a so-called “world space” by applying one or more model transforms (which may also be specified in the state data). Once transformed, GPU 525 may apply a view transform for the active camera (which again may also be specified in the state data defining the camera) to transform the coordinates of the primitives and lights into the camera or eye space. GPU 525 may also perform vertex shading to render the appearance of the primitives in view of any active lights. GPU 525 may perform vertex shading in one or more of the above model, world, or view space.

Once the primitives are shaded, GPU 525 may perform projections to project the image into a canonical view volume. After transforming the model from the eye space to the canonical view volume, GPU 525 may perform clipping to remove any primitives that do not at least partially reside within the canonical view volume. For example, GPU 525 may remove any primitives that are not within the frame of the camera. GPU 525 may then map the coordinates of the primitives from the view volume to the screen space, effectively reducing the three-dimensional coordinates of the primitives to the two-dimensional coordinates of the screen. Given the transformed and projected vertices defining the primitives with their associated shading data, GPU 525 may then rasterize the primitives. Generally, rasterization may refer to the task of taking an image described in a vector graphics format and converting it to a raster image (e.g., a pixelated image) for output on a video display or for storage in a bitmap file format.

A GPU 525 may include a dedicated fast bin buffer (e.g., a fast memory buffer, such as GMEM, which may be referred to by GPU memory 530). As discussed herein, a rendering surface may be divided into bins. In some cases, the bin size is determined by format (e.g., pixel color and depth information) and render target resolution divided by the total amount of GMEM. The number of bins may vary based on device 500 hardware, target resolution size, and target display format. A rendering pass may draw (e.g., render, write, etc.) pixels into GMEM (e.g., with a high bandwidth that matches the capabilities of the GPU). The GPU 525 may then resolve the GMEM (e.g., burst write blended pixel values from the GMEM, as a single layer, to a display buffer 535 or a frame buffer in system memory 540). Such may be referred to as bin-based or tile-based rendering. When all bins are complete, the driver may swap buffers and start the binning process again for a next frame.

For example, GPU 525 may implement a tile-based architecture that renders an image or rendering target by breaking the image into multiple portions, referred to as tiles or bins. The bins may be sized based on the size of GPU memory 530 (e.g., which may alternatively be referred to herein as GMEM or a cache), the resolution of display 545, the color or Z precision of the render target, etc. When implementing tile-based rendering, GPU 525 may perform a binning pass and one or more rendering passes. For example, with respect to the binning pass, GPU 525 may process an entire image and sort rasterized primitives into bins.

The device 500 may use sensor data, sensor statistics, or other data from one or more sensors. Some examples of the monitored sensors may include IMUs, eye trackers, tremor sensors, heart rate sensors, etc. In some cases, an IMU may be included in the device 500, and may measure and report a body's specific force, angular rate, and sometimes the orientation of the body, using some combination of accelerometers, gyroscopes, or magnetometers.

As shown, device 500 may include an extended reality manager 550. The extended reality manager 550 may implement aspects of extended reality, augmented reality, virtual reality, etc. In some cases, such as when the device 500 is implemented as a client device (e.g., device 405 of FIG. 4), the extended reality manager 550 may determine information associated with a user of the device and/or a physical environment in which the device 500 is located, such as facial information, body information, hand information, device pose information, audio information, etc. The device 500 may transmit the information to an animation and scene rendering system (e.g., animation and scene rendering system 410). In some cases, such as when the device 500 is implemented as an animation and scene rendering system (e.g., the animation and scene rendering system 410 of FIG. 4), the extended reality manager 550 may process the information provided by a client device as input information to generate and/or animate a virtual representation for a user of the client device.

Virtual representations (e.g., avatars) are an important component of virtual environments. A virtual representation (or avatar) is a 3D representation of a user and allows the user to interact with the virtual scene As noted previously, there are different ways to represent a virtual representation of a user (e.g., an avatar) and corresponding animation data. For example, avatars may be purely synthetic or may be an accurate representation of the user (e.g., as shown by the virtual representation 302 shown in the image of FIG. 3). A virtual representation (or avatar) may need to be real-time captured or retargeted to reflect the user's actual motion, body pose, facial expression, etc. Because of the many ways to represent an avatar and corresponding animation data, it can be difficult to integrate every single variant of these representations into a scene description.

As noted previously, systems and techniques are described herein for described herein for providing virtual representation (e.g., avatar) encoding in scene descriptions. As described herein, the systems and techniques can decouple the representation of a virtual representation (or avatar) and its animation data from the avatar integration in the scene description. For instance, the systems and techniques can perform virtual representation (or avatar) reconstruction to generate a dynamic mesh that represents a virtual representation (or avatar) of a user, which can allow the systems and techniques to deconstruct the virtual representation (or avatar) into multiple mesh nodes. Each mesh node can correspond to a body part of the virtual representation (or avatar). The multiple mesh nodes enable an XR system to support interactivity with various parts of a virtual representation (e.g., with hands of the avatar).

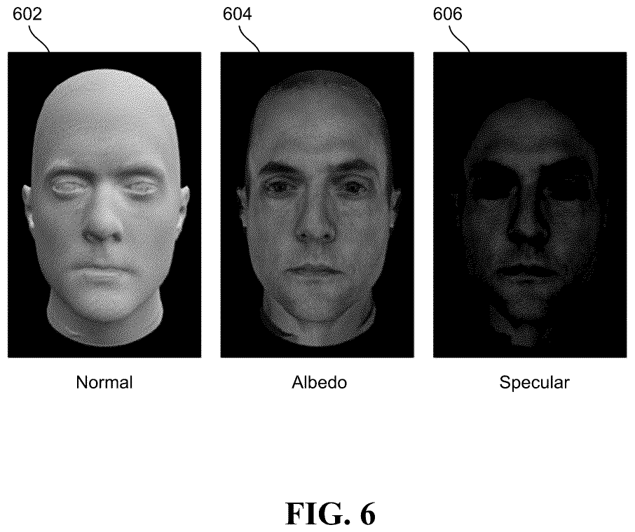

Various animation assets may be needed to model an avatar, including a mesh (e.g., a 3D mesh, such as a triangle mesh, including a plurality of vertices and line segments connected the vertices), a diffuse or albedo texture, normals specular reflection texture, and in some cases other types of textures. These various assets may be available from enrollment or offline reconstruction. FIG. 6 is a diagram illustrating an example of a normal map 602, an albedo map 604, and a specular reflection map 606.

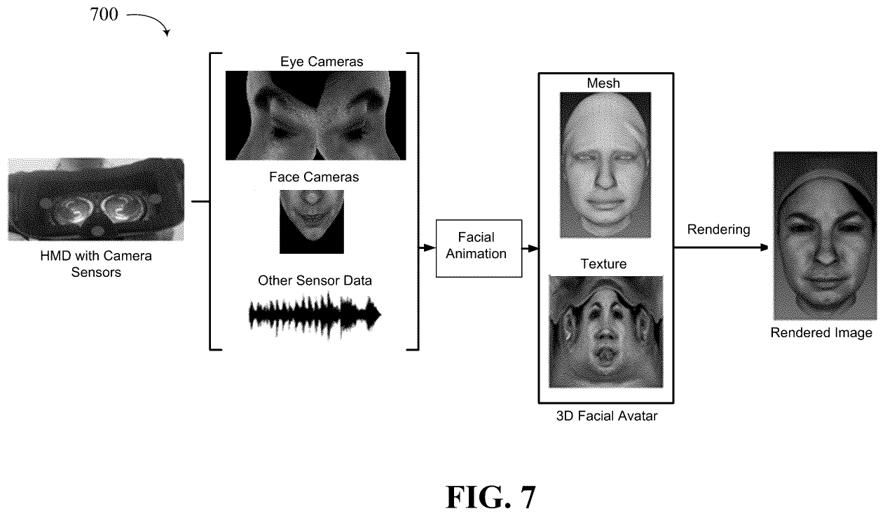

Animation of a virtual representation (e.g., avatar) can be performed using various techniques. FIG. 7 is a diagram 700 illustrating an example of one technique for performing avatar animation. As shown, camera sensors of a head-mounted display (HMD) are used to capture images of a user's face, including eye cameras used to capture images of the user's eyes, face cameras used to capture the visible part of the face (e.g., mouth, chin, cheeks, part of the nose, etc.), and other sensors for capturing other sensor data (e.g., audio, etc.). Facial animation can then be performed to generate a 3D mesh and texture for the 3D facial avatar. The mesh and texture can then be rendered by a rendering engine to generate a rendered image.

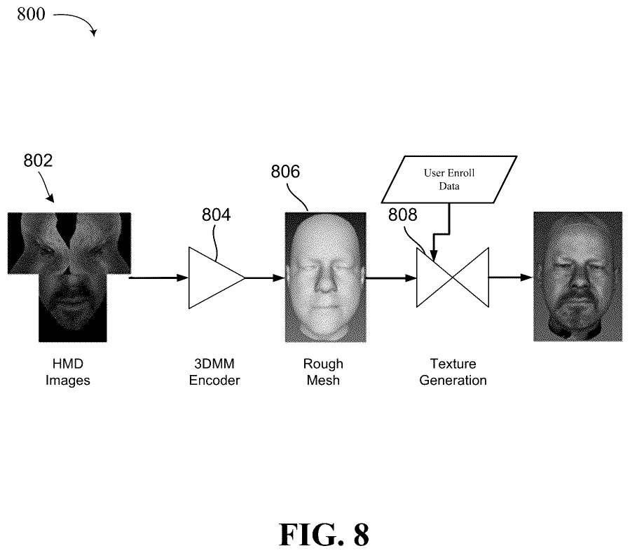

In some cases, facial animation can be performed with or using blend shapes. FIG. 8 is a diagram 800 illustrating an example of performing facial animation with blendshapes. As shown, a system can estimate a rough or course 3D mesh 806 and blend shapes from images 802 (e.g., captured using sensors of an HMD or other XR device) using 3D Morphable Model (3DMM) encoding of a 3DMM encoder 804. The system can generate texture using one or more techniques, such as using a machine learning system 808 (e.g., one or more neural networks) or computer graphics techniques (e.g., Metahumans). In some cases, a system may need to compensate for misalignments due to rough geometry, for example as described in U.S. Non-Provisional Application 17/845,884, filed Jun. 21, 2022 and titled “VIEW DEPENDENT THREE-DIMENSIONAL MORPHABLE MODELS,” which is hereby incorporated by reference in its entirety and for all purposes.

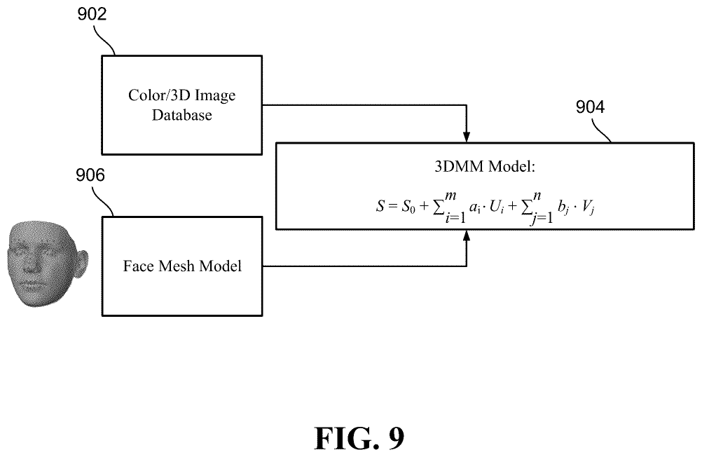

A 3DMM is a 3D face mesh representation of known topology. A 3DMM can be linear or non-linear. FIG. 9 is a diagram illustrating an example of a system 900 that can generate a 3DMM face model or mesh 904. The system 900 can obtain a dataset of 3D and/or color images for various persons (and in some cases grayscale images) from a database 902. The system 900 can also obtain known mesh topologies of face mesh models 906 corresponding to the faces of the images in the database 902. In some cases, Principal Component Analysis (PCA) can be used to find a representation of identifiers (IDs)/expressions in case of linear representations. Expressions can also be modeled via blend shapes (e.g., meshes) at various states or expressions. Using these parameters, the system can manipulate or steer the mesh. The 3DMM can be generated as follows:

S=S₀+Σᵢ₌₁^{m}aᵢ·Uᵢ+Σⱼ₊₁ⁿbⱼ·Vⱼ

The output can include the mean Shape S₀, a shape parameter aᵢ, a shape basis Uᵢ, an expression parameter bⱼ, and an expression basis or blend shape Vⱼ.

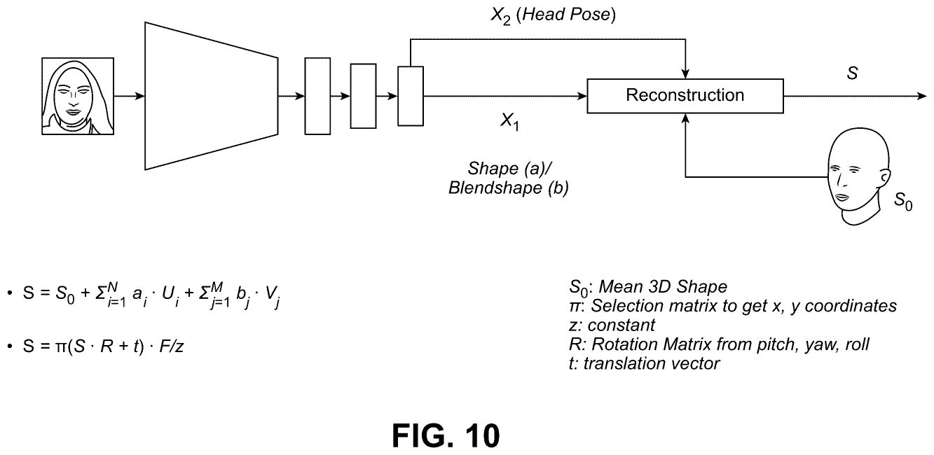

In some cases, blend shapes can be determined using 3DMM encoding. The blend shapes can then be used to reconstruct a deformed mesh, such as to animate an avatar. For instance, as shown in FIG. 10, animating an avatar can be summarized as determining the weight of each blend shape given an input image. Such a technique is described in U.S. Non-Provisional Application 17/384,522, filed Jul. 23, 2021 and titled “ADAPTIVE BOUNDING FOR THREE-DIMENSIONAL MORPHABLE MODELS,” which is hereby incorporated by reference in its entirety and for all purposes. The 3DMM equation S from above is shown in FIG. 10 and provided again below:

$$S = {S}_{0} + {\sum }_{i = 1}^{N} {a}_{i} \cdot {U}_{i} + {\sum }_{j = 1}^{M} {b}_{j} \cdot {V}_{j}$$

and can also be represented as:

s=π(S·R+t)·F/z

where S₀ is a mean 3D shape, π is a selection matrix to obtain the x.y coordinates, z is a constant, R is a rotation matrix from pitch, yaw, roll, and t is a translation vector.

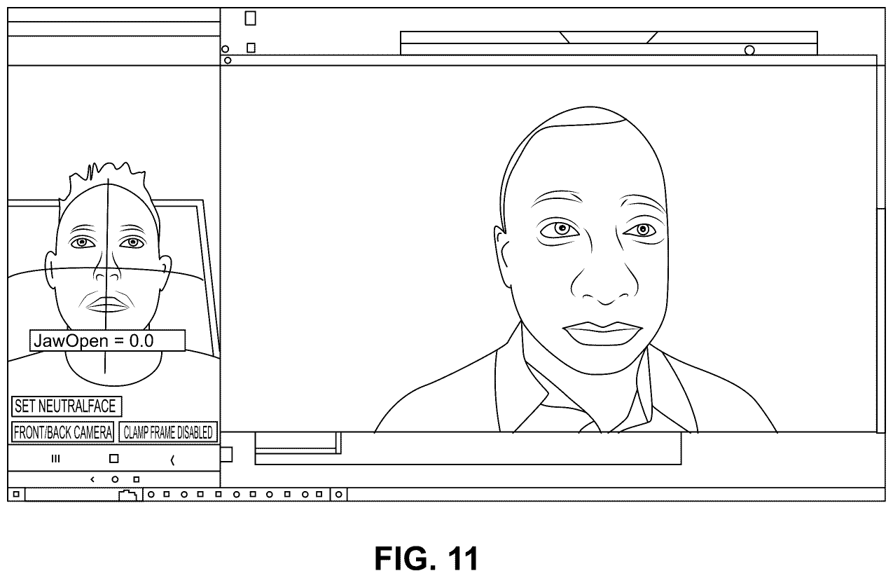

FIG. 11 is a diagram illustrating an example of using a 3DMM fitting curve to drive a virtual representation (or avatar) with a metahuman using the techniques described above.

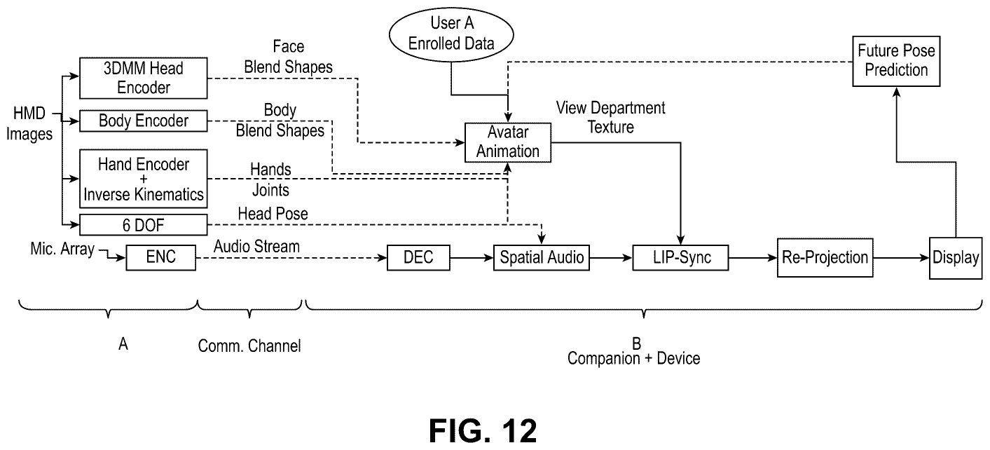

FIG. 12 is a diagram illustrating an example of an end-to-end flow of a system. The flow of FIG. 12 can represent a general flow that can run end-to-end for 1-to-1 communication between a user device A and a user device B, such as described in U.S. Provisional Application 63/371,714, filed Aug. 17, 2022 and titled “DISTRIBUTED GENERATION OF VIRTUAL CONTENT,” which is hereby incorporated by reference in its entirety and for all purposes. In some cases, the system of FIG. 12 can include an additional server node that can be used for a multi-user scenario.

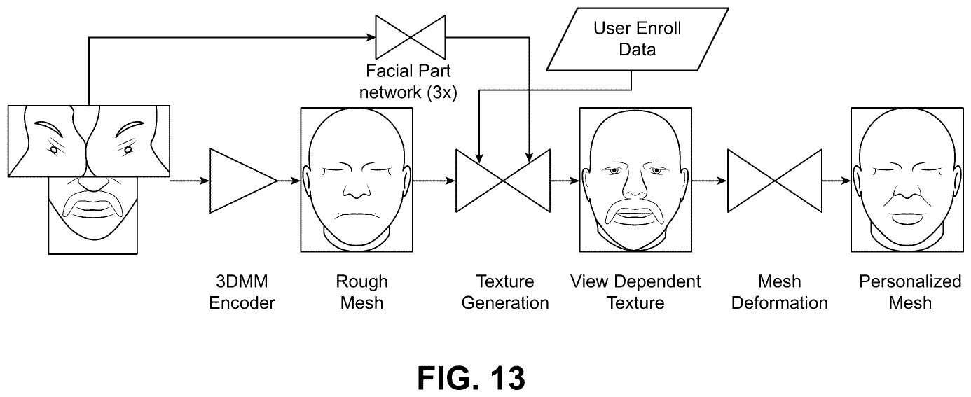

FIG. 13 is a diagram illustrating an example of performing avatar animation. For example, to improve the realism of avatar animation, various techniques can be performed. For example, the system can estimate a rough (or course) mesh and blend shapes from images (e.g., HMD images) using a 3DMM encoder. The system can improve realism of the textures using an additional facial part neural network, such as using techniques described in U.S. Non-Provisional Application 17/813,556, filed Jul. 19, 2022 and titled “FACIAL TEXTURE SYNTHESIS FOR THREE-DIMENSIONAL MORPHABLE MODELS,” which is hereby incorporated by reference in its entirety and for all purposes. As shown, the facial part network may be a neural network including an encoder and a decoder. In some cases, the facial part network may be a neural network including an encoder only (and not an encoder-decoder), in which case the encoder would output features (e.g., a feature vector or embedding vector) representing the part of an input image corresponding to the face. The system can improve realism of the mesh by deforming mesh vertices for a more personalized mesh, such as using techniques described in U.S. Non-Provisional Application 17/714,743, filed Apr. 6, 2022, which is hereby incorporated by reference in its entirety and for all purposes. In some aspects, audio can also be fused into the input of the system of FIG. 13 to improve realism, such as using techniques described in U.S. Non-Provisional Application 17/930,244, filed Sep. 7, 2022 and in U.S. Non-Provisional Application 17/930,257, filed Sep. 7, 2022,” both of which are hereby incorporated by reference in its entirety and for all purposes.

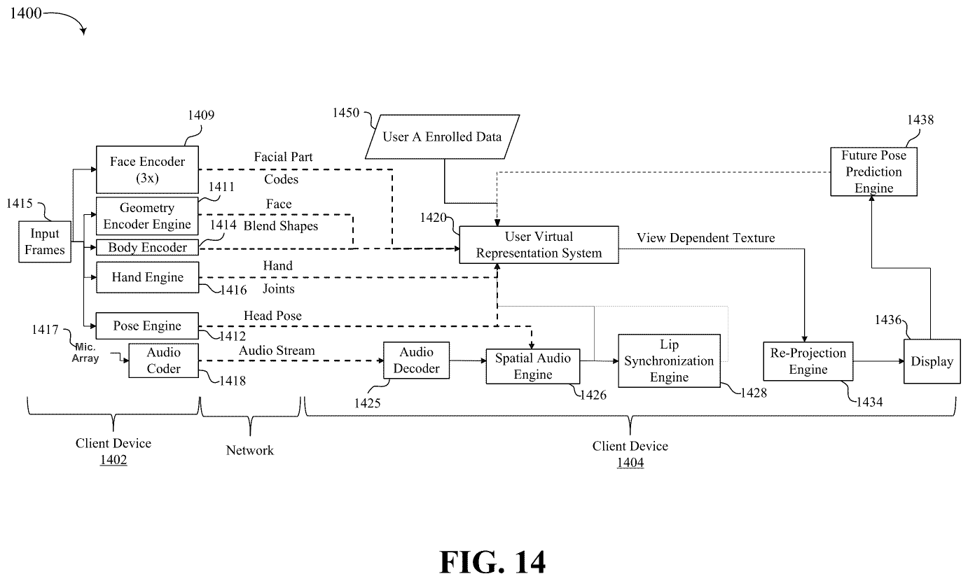

FIG. 14 is a diagram illustrating an example of an example of an XR system 1400 configured with an avatar call flow directly between client devices, in accordance with aspects of the present disclosure. As shown, FIG. 14 includes a first client device 1402 of a first user and a second client device 1404 of a second user. In one illustrative example, the first client device 1402 is a first XR device (e.g., an HMD configured to display VR, AR, and/or other XR content) and the second client device 1404 is a second XR device (e.g., an HMD configured to display VR, AR, and/or other XR content). While two client devices are shown in FIG. 14, the call flow of FIG. 14 can be between the first client device 1402 and multiple other client devices. The XR system 1400 illustrates the first client device 1402 and the second client device 1404 participating in a virtual session (in some cases with other client devices not shown in FIG. 14). In the example of FIG. 14, the client device 1402 can be considered a source (e.g., a source of information for generating at least one frame for the virtual scene) and the second client device 1404 can be considered a target (e.g., a target for receiving the at least one frame generated for the virtual scene).

As noted above, the information sent by a client device may include information representing a face (e.g., codes or features representing an appearance of the face or other information) of a user of the first client device 1402, information representing a body (e.g., codes or features representing an appearance of the body, a pose of the body, or other information) of the user of the first client device 1402, information representing one or more hands (e.g., codes or features representing an appearance of the hand(s), a pose of the hand(s), or other information) of the user of the first client device 1402, pose information (e.g., a pose in six-degrees-of-freedom (6-DOF), referred to as a 6-DOF pose) of the first client device 1402, audio associated with an environment in which the first client device 1402 is located, any combination thereof, and/or other information.

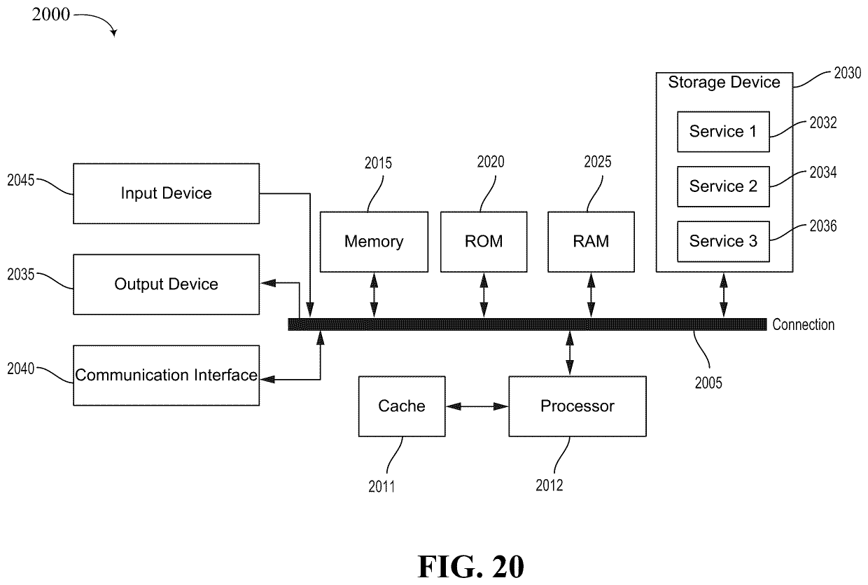

For example, the first computing device 1402 may include a face encoder 1409, geometry encoder engine 1411, a pose engine 1412, a body encoder 1414, a hand engine 1416, and an audio coder 1418. In some aspects, the first client device 1402 may include a body encoder 1414 configured to generate a virtual representation of the user's body. The first client device 1402 may include other components or engines other than those shown in FIG. 14 (e.g., one or more components on the device 500 of FIG. 5, one or more components of the computing system 2000 of FIG. 20, etc.). The second client device 1404 is shown to include a user virtual representation system 1420, audio decoder 1425, spatial audio engine 1426, lip synchronization engine 1428, re-projection engine 1434, a display 1436, and a future pose prediction engine 1438. In some cases, each client device (e.g., first client device 1402, second client device 1402, other client devices) may include a face engine, a pose engine, a body engine, a hand engine, an audio coder (and in some cases an audio decoder or combined audio encoder-decoder), a video decoder (and in some cases a video encoder or combined video encoder-decoder), a re-projection engine, a display, and a future pose prediction engine. These engines or components are not shown in FIG. 14 with respect to the first client device 1402 and the second client device 1404 because the first client device 1402 is a source device and the second client device 1404 is a target device in the example of FIG. 14.

The face encoder 1409 of the first client device 1402 may receive one or more input frames 1415 from one or more cameras of the first client device 1402. For instance, the input frame(s) 1415 received by the face encoder 1409 may include frames (or images) captured by one or more cameras with a field of view of a mouth of the user of the first client device 1402, a left eye of the user, and a right eye of the user. Other images may also be processed by the face encoder 1409. In some cases, the input frame(s) 1415 can be included in a sequence of frames (e.g., a video, a sequence of standalone or still images, etc.). The face encoder 1409 can generate and output a code (e.g., a feature vector or multiple feature vectors) representing a face of the user of the first client device 1402. The face encoder 1409 can transmit the code representing the face of the user to the user virtual representation system 1420 of the second client device 1404. In one illustrative example, the face encoder 1409 may include one or more face encoders that include one or more machine learning systems (e.g., a deep learning network, such as a deep neural network) trained to represent faces of users with a code or feature vector(s). In some cases, the face encoder 1409 can include a separate encoder for each type of image that the face encoder 1409 processes, such as a first encoder for frames or images of the mouth, a second encoder for frames or images of the right eye, and a third encoder for frames or images of the left eye. The training can include supervised learning (e.g., using labeled images and one or more loss functions, such as mean-squared error MSE)), semi-supervised learning, unsupervised learning, etc.). For instance, a deep neural network may generate and output the code (e.g., a feature vector or multiple feature vectors) representing the face of the user of the first client device 1402. The code can be a latent code (or bitstream) that can be decoded by a face decoder (not shown) of the user virtual representation system 1420 that is trained to decode codes (or feature vector) representing faces of users in order to generate virtual representations of the faces (e.g., a face mesh). For example, the face decoder of the user virtual representation system 1420 can decode the code received from the first client device 1402 to generate a virtual representation of the user's face.

A geometry encoder engine 1411 of the first client device 1402 may generate a 3D model (e.g., a 3D morphable model or 3DMM) of the user's head or face based on the one or more frames 1415. In some aspects, the 3D model can include a representation of a facial expression in a frame from the one or more frames 1415. In one illustrative example, the facial expression representation can be formed from blendshapes. Blendshapes can semantically represent movement of muscles or portions of facial features (e.g., opening/closing of the jaw, raising/lowering of an eyebrow, opening/closing eyes, etc.). In some cases, cach blendshape can be represented by a blendshape coefficient paired with a corresponding blendshape vector. In some examples, the facial model can include a representation of the facial shape of the user in the frame. In some cases, the facial shape can be repsresented by a facial shape coefficient paired with a corresponding facial shape vector. In some implementations, the geometry encoder engine 1411 (e.g., a machine learning model) can be trained (e.g., during a training process) to enforce a consistent faical shape (e.g., consistent facial shape coefficients) for a 3D facial model regardless of a pose (e.g., pitch, yaw, and roll) associated with the 3D facial model. For example, when the 3D facial model is rendered into a 2D image or frame for display, the 3D facial model can be projected onto a 2D image or frame using a projection technique.

In some aspects, the blend shape coefficients may be further refined by additionally introducing a relative pose between the first client device 1402 and the second client device 1404. For instance, the relative pose information may be processed using a neural network to generate view-dependent 3DMM geometry that approximates ground truth geometry. In another example, the face geometry may be determined directly from the input frame(s) 1415, such as by estimating additive vertices residual from the input frame(s) 1415 and producing more accurate facial expression details for texture synthesis.

The pose engine 1412 can determine a pose (e.g., 6-DOF pose) of the first client device 1402 (and thus the head pose of the user of the first client device 1402) in the 3D environment. The 6-DOF pose can be an absolute pose. In some cases, the pose engine 1412 may include a 6-DOF tracker that can track three degrees of rotational data (e.g., including pitch, roll, and yaw) and three degrees of translation data (e.g., a horizontal displacement, a vertical displacement, and depth displacement relative to a reference point). The pose engine 1412 (e.g., the 6-DOF tracker) may receive sensor data as input from one or more sensors. In some cases, the pose engine 1412 includes the one or more sensors. In some examples, the one or more sensors may include one or more inertial measurement units (IMUs) (e.g., accelerometers, gyroscopes, etc.), and the sensor data may include IMU samples from the one or more IMUs. The pose engine 1412 can determine raw pose data based on the sensor data. The raw pose data may include 6DOF data representing the pose of the first client device 1402, such as three-dimensional rotational data (e.g., including pitch, roll, and yaw) and three-dimensional translation data (e.g., a horizontal displacement, a vertical displacement, and depth displacement relative to a reference point).

The body encoder 1414 may receive one or more input frames 1415 from one or more cameras of the first client device 1402. The frames received by the body encoder 1414 and the camera(s) used to capture the frames may be the same or different from the frame(s) received by the face encoder 1409 and the camera(s) used to capture those frames. For instance, the input frame(s) received by the body encoder 1414 may include frames (or images) captured by one or more cameras with a field of view of body (e.g., a portion other than the face, such as a neck, shoulders, torso, lower body, feet, of the user etc.) of the user of the first client device 1402. The body encoder 1414 can perform one or more techniques to output a representation of the body of the user of the first client device 1402. In one example, the body encoder 1414 can generate and output a 3D mesh (e.g., including a plurality of vertices, edges, and/or faces in 3D space) representing a shape of the body. In another example, the body encoder 1414 can generate and output a code (e.g., a feature vector or multiple feature vectors) representing a body of the user of the first client device 1402. In one illustrative example, the body encoder 1414 may include one or more body encoders that include one or more machine learning systems (e.g., a deep learning network, such as a deep neural network) trained to represent bodies of users with a code or feature vector(s). The training can include supervised learning (e.g., using labeled images and one or more loss functions, such as MSE), semi-supervised learning, unsupervised learning, etc.). For instance, a deep neural network may generate and output the code (e.g., a feature vector or multiple feature vectors) representing the body of the user of the first client device 1402. The code can be a latent code (or bitstream) that can be decoded by a body decoder (not shown) of the user virtual representation system 1420 that is trained to decode codes (or feature vectors) representing virtual bodies of users in order to generate virtual representations of the bodies (e.g., a body mesh). For example, the body decoder of the user virtual representation system 1420 can decode the code received from the first client device 1402 to generate a virtual representation of the user's body.

The hand engine 1416 may receive one or more input frames 1415 from one or more cameras of the first client device 1402. The frames received by the hand engine 1416 and the camera(s) used to capture the frames may be the same or different from the frame(s) received by the face encoder 1409 and/or the body encoder 1414 and the camera(s) used to capture those frames. For instance, the input frame(s) received by the hand engine 1416 may include frames (or images) captured by one or more cameras with a field of view of hands of the user of the first client device 1402. The hand engine 1416 can perform one or more techniques to output a representation of the one or more hands of the user of the first client device 1402. In one example, the hand engine 1416 can generate and output a 3D mesh (e.g., including a plurality of vertices, edges, and/or faces in 3D space) representing a shape of the hand(s). In another example, the hand engine 1416 can output a code (e.g., a feature vector or multiple feature vectors) representing the one or more hands. For instance, the hand engine 1416 may include one or more body encoders that include one or more machine learning systems (e.g., a deep learning network, such as a deep neural network) that are trained (e.g., using supervised learning, semi-supervised learning, unsupervised learning, etc.) to represent hands of users with a code or feature vector(s). The code can be a latent code (or bitstream) that can be decoded by a hand decoder (not shown) of the animation and scene rendering system 1410 that is trained to decode codes (or feature vectors) representing virtual hands of users in order to generate virtual representations of the bodies (e.g., a body mesh). For example, the hand decoder of the user virtual representation system 1420 can decode the code received from the first client device 1402 to generate a virtual representation of the user's hands (or one hand in some cases).

The audio coder 1418 (e.g., audio encoder or combined audio encoder-decoder) can receive audio data, such as audio obtained using one or more microphones 1417 of the first client device 1402. The audio coder 1418 can encode or compress audio data and transmit the encoded audio to the audio decoder 1425 of the second client device 1404. The audio coder 1418 can perform any type of audio coding to compress the audio data, such as a Modified discrete cosine transform (MDCT) based encoding technique. The encoded audio can be decoded by the audio decoder 1425 of the second client device 1404 that is configured to perform an inverse process of the audio encoding process performed by the audio coder 1418 to obtain decoded (or decompressed) audio.

The user virtual representation system 1420 of the second client device 1404 can receive the input information received from the first client device 1402 and use the input information to generate and/or animate a virtual representation (or avatar) of the user of the first client device 1402. In some aspects, the user virtual representation system 1420 may also use a future predicted pose of the second client device 1404 to generate and/or animate the virtual representation of the user of the first client device 1402. In such aspects, the future pose prediction engine 1438 of the second client device 1404 may predict pose of the second client device 1404 (e.g., corresponding to a predicted head pose, body pose, hand pose, etc. of the user) based on a target pose and transmit the predicted pose to the user virtual representation system 1420. For instance, the future pose prediction engine 1438 may predict the future pose of the second client device 1404 (e.g., corresponding to head position, head orientation, a line of sight such as view 130-A or 130-B of FIG. 1, etc. of the user of the second client device 1404) for a future time (e.g., a time T, which may be the prediction time) according to a model. The future time T can correspond to a time when a target view frame will be output or displayed by the second client device 1404. As used herein, reference to a pose of a client device (e.g., second client device 1404) and to a head pose, body pose, etc. of a user of the client device can be used interchangeably.

The predicted pose can be useful when generating a virtual representation because, in some cases, virtual objects may appear delayed to a user when compared to an expected view of the objects to the user or compared with real-world objects that the user is viewing (e.g., in an AR, MR, or VR see-through scenario). Referring to FIG. 1 as an illustrative example, without head motion or pose prediction, updating of virtual objects in view 130-B from the previous view 130-A may be delayed until head pose measurements are conducted such that the position, orientation, sizing, etc. of the virtual objects may be updated accordingly. In some cases, the delay may be due to system latency (e.g., end-to-end system delay between second client device 1404 and a system or device rendering the virtual content, such as the user virtual representation system 1420), which may be caused by rendering, time warping, or both. In some cases, such delay may be referred to as round trip latency or dynamic registration error. In some cases, the error may be large enough that the user of second client device 1404 may perform a head motion (e.g., the head motion 115 illustrated in FIG. 1) before a time pose measurement may be ready for display. Thus, it may be beneficial to predict the head motion 115 such that virtual objects associated with the view 130-B can be determined and updated in real-time based on the prediction (e.g., patterns) in the head motion 115.

As noted above, the user virtual representation system 1420 may use the input information received from the first client device 1402 and the future predicted pose information from the future pose prediction engine 1438 to generate and/or animate the virtual representation of the user of the first client device 1402. As noted herein, animation of the virtual representation of the user can include modifying a position, movement, mannerism, or other feature of the virtual representation to match a corresponding position, movement, mannerism, etc. of the user in a real-world or physical space. In some aspects, the user virtual representation system 1420 may be implemented as a deep learning network, such as a neural network (e.g., a convolutional neural network (CNN), an autoencoder, or other type of neural network) trained based on input training data (e.g., codes representing faces of users, codes representing bodies of users, codes representing hands of users, pose information such as 6-DOF pose information of client devices of the users, inverse kinematics information, etc.) using supervised learning, semi-supervised learning, unsupervised learning, etc. to generate and/or animate virtual representations of users of client devices.

In some cases, the user virtual representation system 1420 can receive user enrolled data 1450 of the first user (user A) of the first client device 1402 to generate a virtual representation (e.g., an avatar) for the first user. The enrolled data 1450 of the first user can include the mesh information. The mesh information can include information defining the mesh of the avatar of the first user of the first client device 1402 and other assets associated with the avatar (e.g., a normal map, an albedo map, a specular reflection map, etc.). In some cases, mesh animation parameters can include the facial part codes from the face encoder 1409, the face blend shapes from the geometry encoder engine 1411 (which may include a 3DMM head encoder in some cases), the hand joints codes from the hand engine 1416, the head pose from the pose engine 1412, and in some cases the audio stream from the audio coder 1418.

In some cases, a spatial audio engine 1426 may receive as input the decoded audio generated by the audio decoder 1425 and in some cases the future predicted pose information from the future pose prediction engine 1438. Using the inputs to generate audio that is spatially oriented according to the pose of the user of the second client device 1404. A lip synchronization engine 1428 can synchronize the animation of the lips of the virtual representation of the user of the first client device 1402 depicted in the display 1436 with the spatial audio output by the spatial audio engine 1426.

A re-projection engine 1434 can perform re-projection to re-project the virtual content of the decoded target view frame according to the predicted pose determined by the future pose prediction engine 1438. The re-projected target view frame can then be displayed on the display 1436 so that the user of the second client device 1404 can view the virtual scene from that user's perspective.

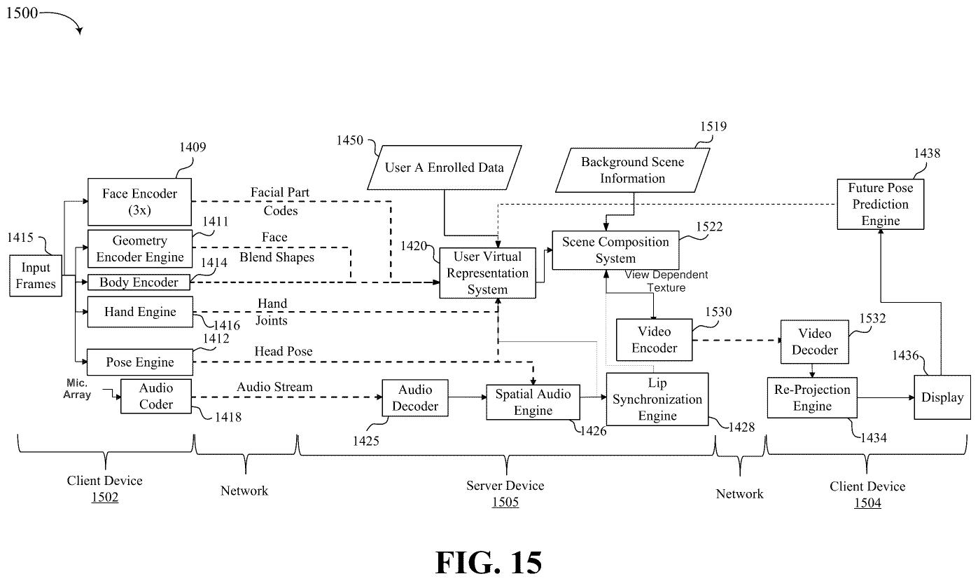

FIG. 15 is a diagram illustrating an example of an example of an XR system 1500 configured with an avatar call flow directly between client devices, in accordance with aspects of the present disclosure. As shown in FIG. 15, the XR system 1500 includes some of the same components (with like numerals) as the XR system 1400 of FIG. 14. For example, the face encoder 1409, the geometry encoder engine 1411, the pose engine 1412, the body encoder 1414, the hand engine 1416, the audio coder 1418, the user virtual representation system 1420, which can receive user enrolled data 1450, the audio decoder 1425, the spatial audio engine 1426, the lip synchronization engine 1428, the re-projection engine 1434, the display 1436, and the future pose projection engine 1438 are configured to perform the same or similar operations as the same components of the XR system 1400 of FIG. 14.

The XR system 1500 also includes a scene composition system 1522, which may receive background scene information 1519, a video encoder 1530, and a video decoder 1532. In some cases, the user virtual representation system 1420 may output the virtual representation of the user of the first client device 1502 to a scene composition system 1522, which may be part of or implemented by a server device 1505. Background scene information 1519 and virtual representations of other users participating in the virtual session (if any exist) may also be provided to the scene composition system 1522. The background scene information 1519 can include information about the scene, such as lighting of the virtual scene, virtual objects in the scene (e.g., virtual buildings, virtual streets, virtual animals, etc.), and/or other details related to the virtual scene (e.g., a sky, clouds, etc.). In some cases, such as in an AR, MR, or VR see-through setting (where video frames of a real-world environment are displayed to a user), the lighting information can include lighting of a real-world environment in which the first client device 1502 and/or the second client device 1504 (and/or other client devices participating in the virtual session) are located. In some cases, the future predicted pose from the future pose prediction engine 1438 of the second client device 1504 may also be input to the scene composition system 1522.

Using the virtual representation of the user of the first client device 1502, the background scene information 1519, and virtual representations of other users (if any exist) (and in some cases the future predicted pose), the scene composition system 1522 can compose target view frames for the virtual scene with a view of the virtual scene from the perspective of the user of the second client device 1504 based on a relative difference between the pose of the second client device 1504 and each respective pose of the first client device 1502 and any other client devices of users participating in the virtual session. For example, a composed target view frame can include a blending of the virtual representation of the user of the first client device 1502, the background scene information 1519 (e.g., lighting, background objects, sky, etc.), and virtual representations of other users that may be involved in the virtual session. The poses of virtual representations of any other users are also based on a pose of the second client device 1504 (corresponding to a pose of the user of the second client device 1504).

The video encoder 1530 can encode (or compress) the target view frames from the scene composition system 1522 using a video coding technique (e.g., according to any suitable video codec, such as advanced video coding (AVC), high efficiency video coding (HEVC), versatile video coding (VVC), moving picture experts group (MPEG), etc.). The video encoder 1530 may then transmit encoded target view frames to the second client device 1504 via the network.

A video decoder 1532 of the second client device 1504 may obtain the encoded target view frames and may decode the encoded target view frames using an inverse of the video coding technique performed by the video encoder 1530 (e.g., according to a video codec, such as AVC, HEVC, VVC, etc.). The re-projection engine 1434 can perform re-projection to re-project the virtual content of the decoded target view frame according to the predicted pose determined by the future pose prediction engine 1438. The re-projected target view frame can then be displayed on a display 1436 so that the user of the second client device 1504 can view the virtual scene from that user's perspective.

In some cases, for full-body pose estimation and avatar animation, a system may predict body shape/pose parameters. SMPL or ADAM body models can be used that can be parametrizable like 3DMM. Prediction may occur from images captured using cameras on an XR device (e.g., an HMD) and/or attached body sensors. The system can apply shape and pose deformation to the base model.

Aspects of 3D reconstruction can be challenging, including mouth opening, hair and facial hair, eyes, emotions, interactivity with the virtual representation or avatar, etc.

Various standards exist that are related to animation. For example, W3D has created a standard on humanoid animation, https://www.web3d.org/documents/specifications/19774-1/V2.0/index.html. The standard defines the joints of the humanoid model and their hierarchy and defines a hierarchical model of the humanoid. Humanoid components include body segments, joints, skeleton, skin with normal and coordinates, and transformations. It also defines sites where interactivity can be attached. Animations are defined in Part 2 at https://www.web3d.org/documents/specifications/19774-2/V2.0/index.html, which supports interpolation and motion objects.

There are various problems associated with virtual representations (e.g., avatars) of users in virtual environments. For example, different applications/platforms may use different representations of virtual representations (or avatars). Further, in a shared space, virtual representations (or avatars) from all participants have to be composited into a single scene. It can be difficult to support a wide range of virtual representations (or avatars) representations in a scene description. A solution to such a problem should support a wide range of virtual representations (e.g., avatar representations), captured and synthetic avatars, animated and frame-by-frame avatars, and interactivity involving different parts of the avatar.

The systems and techniques described herein provide a way to integrate virtual representations (e.g., avatars) into a scene description. In some cases, a virtual scene may be described by a schema, such as a Graphics Language Transmission Format (glTF). The glTF may describe a virtual scene using a plurality of hierarchical tree structures describing the environment of the scene, objects in the scene, etc. In some cases, the glTF can also be used to describe virtual representations. For example, a virtual representation may include a mesh (e.g., head mesh, body mesh, etc.) onto which textures may be overlaid. In some cases, it can be useful to map segments (e.g., portions) of the mesh to humanoid components, such as body segments, that may be defined in the glTF. For example, animations and interactions may be defined based a hierarchical model of a humanoid with certain animations and/or interactions defined based on human components, such as body segments, joints, etc. For example, a glTF node may be associated with a hand, which may be mapped to a portion of the mesh and associated with an ability to touch (e.g., interact with) other objects in the environment. These interactions and/or animations may define how parts of a body mesh may be deformed, moved, warped, etc.

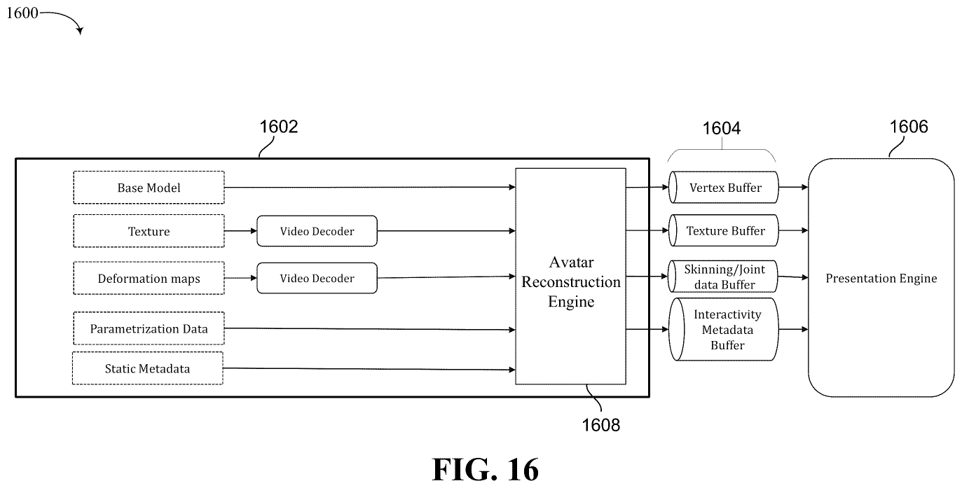

FIG. 16 is a block diagram illustrating an example of a virtual representation (or avatar) reconstruction system or pipeline 1600, in accordance with aspects of the present disclosure. In some cases, the virtual representation reconstruction system 1600 may be included as a part of the user virtual representation system 1420 of FIGS. 14 and 15. The virtual representation reconstruction system 1600 may include a mesh generation engine 1602, a set of buffers 1604, and a presentation engine 1606.

The mesh generation engine 1602 may include an avatar reconstruction engine 1608 which receives input information. In some cases, the input information may be received as one or more data streams or channels. For instance, the input information is received via a set of data streams including streams for a base model, which may be a generic mesh model of a virtual representation, texture information, deformation maps, parameterization data, and static metadata. The input information may be provided as input to the avatar reconstruction engine 1608.

The avatar reconstruction engine 1608 can generate components of the virtual representation, such as a vertices for the geometry of the mesh, texture information, skinning information for the textures, location of joints, interactivity information, etc., as 3D meshes. In some cases, the avatar reconstruction engine 1608 may include a set of machine learning (ML) models and/or algorithms. The components of the virtual representation may be stored in the set of buffers 1604. The set of buffers 1604 may include buffers for various types of information, such as vertex information for the mesh, texture information for the mesh, skinning/joint information for the mesh, attribute information for the mesh, interactivity and/or metadata for the mesh, etc. In some cases, the components of the virtual representation may be stored in a single combined buffer.

The output of the avatar reconstruction engine 1608 may be output from the set of buffers 1604 to the presentation engine 1606. For example, the presentation engine 1606 can receive the 3D meshes from the set of buffers 1604 and render the virtual representation. As shown, the presentation engine 1606 does not have a dependency on specific input information for the avatar reconstruction engine 1608. For instance, the presentation engine receives and processes the relevant meshes to render from the avatar reconstruction engine 1608 without respect to the input information provided to the avatar reconstruction engine 1608. The presentation engine 1606 can thus render the data in the buffer(s), allowing the specific input information for the avatar reconstruction engine 1608 to vary without affecting the presentation engine 1606.

In some aspects, the input information for the avatar reconstruction engine 1608 may vary, for example, based on a format (or type) of the virtual representation. In some cases, the format of the virtual representation may vary based on a particular vendor that is responsible for the virtual representation, a complexity of the virtual representation, a particular computing system being used, any combination thereof, and/or other information. For example, a virtual representation generated by a first vendor may include different input information streams which may be handled differently by the avatar reconstruction engine 1608 as compared to virtual representations generated by a second vendor. In another example, input information provided for a virtual representation from one vendor may not include specular textures, may use a different base model, may be interactive at different locations, etc., as compared to a virtual representation from another vendor. In some cases, a format of virtual representation may vary, for example, based on an account level (e.g., premium account, regular account, etc.), device being used, available bandwidth, etc.

By decoupling the presentation engine 1606 from the specific input information. different formats of virtual representations may be accommodated by adapting the avatar reconstruction engine 1608 to the different formats of virtual representations. For example, the avatar reconstruction engine 1608 may have multiple ML models, each trained to generate meshes from one or more different formats of virtual representations, or multiple avatar reconstruction engines 1608 may be used to generate meshes from one or more different formats of virtual representations. In some cases, while different input information may be received for different virtual representation formats, the input information itself may be arranged into and/or described by a common schema or format, such as gLTF.

In some cases, it may be useful to provide enhanced techniques to integrate virtual representations into such schema by extending a mesh element (e.g., a gLTF mesh element) to represent a virtual representation or a part of a virtual representation (e.g., an avatar or a part of an avatar). For example, a common schema may be defined to accommodate different formats of virtual representations. Each part of the virtual representation (or avatar) can be associated with a part of a humanoid and may be associated with certain interactivity behavior.

In some cases, a root node of the virtual representation (or avatar) can describe how the virtual representation is represented. The root node may have one or more children each associated with a humanoid part. For example, a child mesh node may indicate which humanoid part applies to that child mesh node through a path scheme (e.g., “/humanoid/arms/left/hand”).

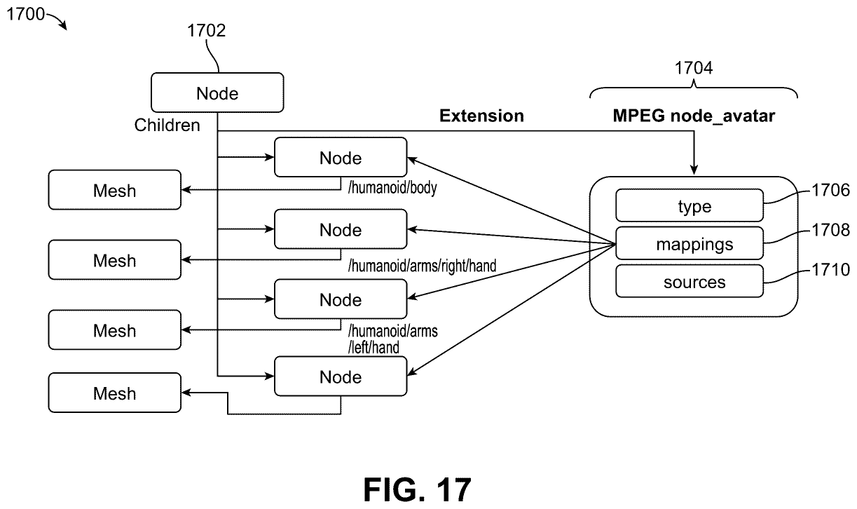

FIG. 17 is a diagram illustrating a structure of a virtual representation (or avatar) in glTF 1700, in accordance with aspects of the present disclosure. FIG. 17 includes a root node 1702 (e.g., parent node), under which child nodes representing the virtual representation are hierarchically arranged. In some cases, this hierarchical arrangement may be based on humanoid components, such as body segments such as a body (e.g., torso), arms, hands, fingers, legs, etc. with smaller sub-segments, such as fingers, represented by child nodes (e.g., sub-nodes) of larger components, such as hands. In some cases, the body segments (and sub-segments) and hierarchy for the nodes may be defined based on a hierarchical model of a humanoid, such as that provided in the W3D standard.

In some cases, a virtual representation framework that is used to generate a virtual representation (e.g., for generating a virtual representation in a particular virtual representation format) specifies how information is arranged in the input information and how to map segments (or processed segments) of the input information into a node structure of a glTF schema. For example, to allow different virtual representation formats to be used with a common presentation engine, a structure for interpreting the different virtual representation formats may be provided. As an example of such a structure, the root node 1702 may include one or more fields 1704 which help allow different virtual representation formats to be accommodated. The fields 1704 may include a type field 1706, a mappings field 1708, and a sources field 1710. While the root node 1702 is illustrated in FIG. 17 as a first node (e.g., trunk node, root node, primary node, etc.) for the virtual representation, the root node 1702 may be a child node for the glTF representing a scene. Further, while the one or more fields 1704 are described as a part of the root node 1702, it should be understood that the one or more fields 1704 may be included in any defined segment of the node structure for the virtual representation. For example, the one or more fields 1704 may be included in a specific child node of the node structure.

In some cases, the type field 1706 may be used to indicate a format for the virtual representation (e.g., the virtual representation framework used to generate the virtual representation). As an example, the type field may include a uniform resource name (URN) or uniform resource locator (URL) indicating the format for the virtual representation. The URN/URL may provide an indication of the format for the virtual representation, which may be used to determine how (e.g., which algorithm) to use for reconstructing the virtual representation.

The mappings field 1708 may indicate one or more child nodes (e.g., sub-nodes) under the root node 1702 that correspond to various body segments. For example, the presentation engine 1606 may use the mappings field 1708 to determine where in the glTF to find information about certain body segments which have interactivity. The mappings field 1708 may indicate that, for example, information about the right hand is in a particular node of the node hierarchy and that the node is associated with interactivity information that may be in another node of the node hierarchy. In some cases, the interactivity information of a node/sub-node may include information about whether and/or how the body segment associated with the node/sub-node can interact with other objects and/or the environment.

The sources field 1710 may indicate where certain information may be located in the input information. For example, the input information may be received in one or more data streams, and the sources field 1710 may include information indicating where in the data streams certain information is located. As a more specific example, the sources field 1710 may indicate that body pose information may be available in a certain segment of a deformation map data stream.

Upon reconstruction of the virtual representation (or avatar) from its representation, the mesh data can be mapped to the signaled mesh structure. The system can map interactivity metadata into the reconstructed virtual representation (or avatar) mesh.

The scene description can include a description of the 3D reconstructed virtual representation (or avatar) as a dynamic mesh and/or as a skinned mesh. The system or pipeline of FIG. 17 may take different representations of the virtual representation (or avatar) and perform the 3D reconstruction. The reconstructed avatar components may then be fed into the presentation engine of FIG. 16 for rendering. Examples of inputs into the system of FIG. 16 can include basic meshes, one or more different types of textures, color images (e.g., red-green-blue (RGB) images) and/or depth images, deformation parameters, skinning weights, any combination thereof, and/or other inputs.

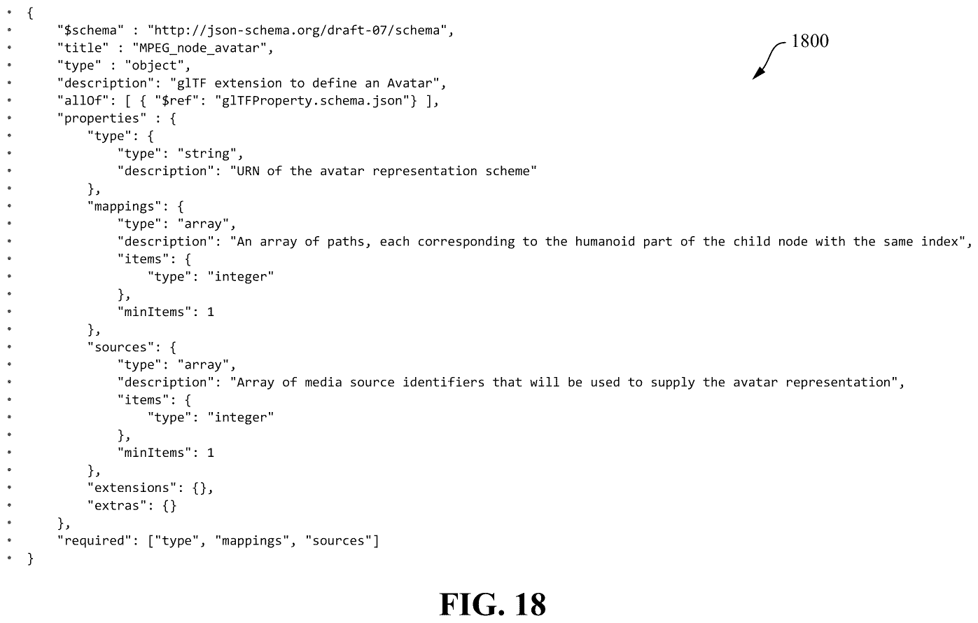

FIG. 18 is an example of a JavaScript Object Notation (JSON) schema 1800 for the systems and techniques described herein. In the example schema 1800, the type field includes a URN indicating a format for the virtual representation. The mappings field includes an array of paths into the node hierarchy of the nodes representing the virtual representation and the paths correspond the humanoid parts to child nodes (e.g., sub-nodes) in the node hierarchy. The sources field include an array of pointers (e.g., links) to where information for the virtual representation may be located in the input information data streams.

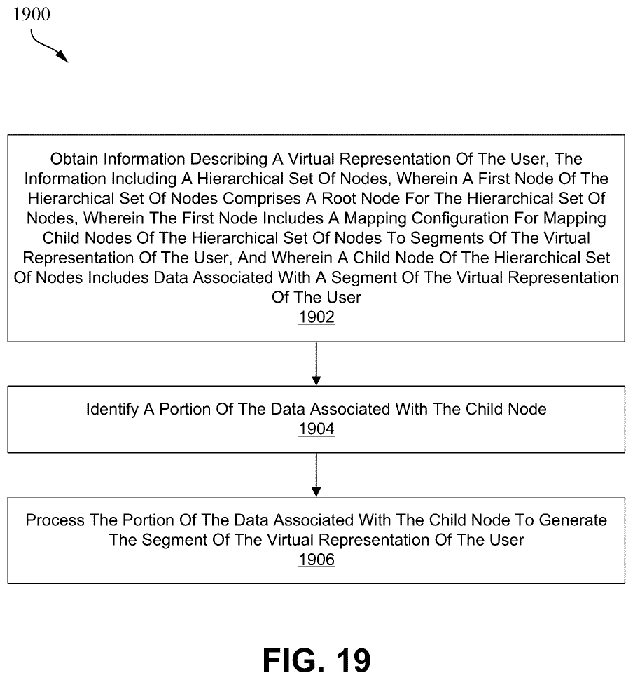

FIG. 19 is a flow diagram illustrating a process 1900 for generating virtual content in a distributed system, in accordance with aspects of the present disclosure. The process 1900 may be performed by a computing device (or apparatus) or a component (e.g., a chipset, codec, etc.) of the computing device, such as CPU 510 and/or GPU 525 of FIG. 5, and/or processor 2012 of FIG. 20. The computing device may be an animation and scene rendering system (e.g., an edge or cloud-based server, a personal computer acting as a server device, a mobile device such as a mobile phone acting as a server device, an XR device acting as a server device, a network router, or other device acting as a server or other device). The operations of the process 1900 may be implemented as software components that are executed and run on one or more processors (e.g., CPU 510 and/or GPU 525 of FIG. 5, and/or processor 2012 of FIG. 20).

At block 1902, the computing device (or component thereof) may obtain information describing a virtual representation of a user (e.g., glTF 1700 of FIG. 17), the information including a hierarchical set of nodes. A first node of the hierarchical set of nodes includes a root node for the hierarchical set of nodes. The first node includes a mapping configuration (e.g., mapping field 1708 of FIG. 17) for mapping child nodes of the hierarchical set of nodes to segments of the virtual representation of the user. A child node of the hierarchical set of nodes includes data associated with a segment of the virtual representation of the user. In some cases, the segment includes at least one body part of the virtual representation of the user. In some cases, the segment of the virtual representation of the user comprises a body part of the virtual representation of the user. In some cases, the body part of the virtual representation of the user comprises a humanoid component. In some cases, the first node comprises a root node (e.g., root node 1702 of FIG. 17) for the hierarchical set of nodes. In some examples, the first node includes type information, and the portion of the data associated with the child node is processed based on the type information (e.g., type field 1706 of FIG. 17). In some cases, the type information comprises information indication how the virtual representation of the user is represented. In some examples, the type information comprises a universal resource name indicating the format for the virtual representation of the user. In some cases, the type information may be used to indicate a format for the virtual representation of the user (e.g., the virtual representation framework used to generate the virtual representation of the user). In some examples, the computing device (or component thereof) may process the portion of the data associated with the child node by processing the portion of the data associated with the child node based on the indicated format for the virtual representation of the user. In some cases, the first node includes source information, and wherein the portion of the data associated with the child node is identified based on source information. In some examples, the data comprises one or more data streams, and wherein the one or more data streams is based on the format for the virtual representation of the user. For example, the daya may be received via a set of data streams including streams for a base model, which may be a generic mesh model of a virtual representation of the user, texture information, deformation maps, parameterization data, and static metadata. In some cases, a sub-node of the child node includes data associated with a sub-segment of the segment of the virtual representation of the user. In some examples, the mappings may indicate one or more child nodes (e.g., sub-nodes) under the root node that correspond to various body segments.

At block 1904, the computing device (or component thereof) may identify a portion of the data associated with the child node. In some cases, the sources information may indicate where certain information may be located in the input information. In some cases, the portion of the data associated with the child node includes interactivity information indicating whether the segment of the virtual representation of the user can interact with other objects.

At block 1906, the computing device (or component thereof) may process the portion of the data associated with the child node to generate a segment of the virtual representation of the user. In some cases, the generated segment of the virtual representation of the user comprises mesh information. In some cases, the computing device (or component thereof) may process the mesh information to render the generated segment of the virtual representation of the user.

The systems and techniques described herein provide interactivity with virtual representations (or avatars). For example, the systems and techniques provide a mapping scheme between the input avatar components and the output avatar. The systems and techniques also provide a standardized naming scheme for scene nodes that map to avatar segments (e.g., thumb, right/left hand, etc.). The interactivity can be assigned to avatars using the standardized naming scheme, such as /humanoid/arms/left/fingers/index triggers a light on when in proximity of light switch. The mapping may use one of the input components, such as a base humanoid or unposed geometry parts, texture coordinates in a texture map (e.g., patch (x,y,w,h) maps to left hand index finger), a combination thereof, or other inputs.

As described above, the systems and techniques decouple a virtual representation (e.g., an avatar representation) from the virtual representation integration in the scene description. The systems and techniques allow referencing different types of avatar representations and mapping the reconstructed 3D avatar onto humanoid parts that can be associated with interactivity behaviors.

In some cases, the computing devices or apparatuses configured to perform the operations of one or more of the processes described herein may include a processor, microprocessor, microcomputer, or other component of a device that is configured to carry out the steps of the process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The operations of the various processes can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

FIG. 20 is a diagram illustrating an example of a system for implementing certain aspects of the present technology. In particular, FIG. 20 illustrates an example of computing system 2000, which can be for example any computing device making up internal computing system, a remote computing system, a camera, or any component thereof in which the components of the system are in communication with each other using connection 2005. Connection 2005 can be a physical connection using a bus, or a direct connection into processor 2010, such as in a chipset architecture. Connection 2005 can also be a virtual connection, networked connection, or logical connection.

In some aspects, computing system 2000 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 2000 includes at least one processing unit (CPU or processor) 2010 and connection 2005 that couples various system components including system memory 2015, such as read-only memory (ROM) 2020 and random-access memory (RAM) 2025 to processor 2010. Computing system 2000 can include a cache 2011 of high-speed memory connected directly with, in close proximity to, or integrated as part of processor 2010.

Processor 2010 can include any general-purpose processor and a hardware service or software service, such as services 2032, 2034, and 2036 stored in storage device 2030, configured to control processor 2010 as well as a special-purpose processor where software instructions are incorporated into the actual processor design. Processor 2010 may essentially be a completely self-contained computing system, containing multiple cores or processors, a bus, memory controller, cache, etc. A multi-core processor may be symmetric or asymmetric.

To enable user interaction, computing system 2000 includes an input device 2045, which can represent any number of input mechanisms, such as a microphone for speech, a touch-sensitive screen for gesture or graphical input, keyboard, mouse, motion input, speech, etc. Computing system 2000 can also include output device 2035, which can be one or more of a number of output mechanisms. In some instances, multimodal systems can enable a user to provide multiple types of input/output to communicate with computing system 2000. Computing system 2000 can include communications interface 2040, which can generally govern and manage the user input and system output.

The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, WLAN signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/long term evolution (LTE) cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 2040 may also include one or more GNSS receivers or transceivers that are used to determine a location of the computing system 2000 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 2030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a Europay, Mastercard and Visa (EMV) chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/RcRAM), phase change memory (PCM), spin transfer torque RAM (STT-RAM), another memory chip or cartridge, and/or a combination thereof.

The storage device 2030 can include software services, servers, services, etc., that when the code that defines such software is executed by the processor 2010, it causes the system to perform a function. In some aspects, a hardware service that performs a particular function can include the software component stored in a computer-readable medium in connection with the necessary hardware components, such as processor 2010, connection 2005, output device 2035, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information. data, arguments, parameters, or memory contents. Information, arguments, parameters, data, etc. may be passed, forwarded, or transmitted via any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or

B and C. A and B and C, or any duplicate information or data (e.g., A and A, B and B, C and C. A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably hercin.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically crasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. A method for generating a virtual representation of a user, comprising: receiving data describing a virtual representation of the user, the data including a hierarchical set of nodes, wherein a first node of the set of nodes includes type information, source information, a mapping, or a combination thereof, and wherein a child node of the hierarchical set of nodes includes data associated with a segment of the virtual representation of the user; identifying, based on the type information, a format associated with the virtual representation of the user; identifying, based on the mapping, the child node in the hierarchical set of nodes; identifying, based on the source information, a segment of the data associated with the child node; and processing the data associated with the segment of the data associated with the child node based on a corresponding format for the virtual representation of the user to generate a segment of the virtual representation of the user.

Aspect 2. The method of Aspect 1, wherein a sub-node of the child node includes data associated with a sub-segment of the segment of the virtual representation of the user.

Aspect 3. The method of any one of Aspects 1 or 2, wherein the segment of the virtual representation comprises a body part of the virtual representation of the user.

Aspect 4. The method of Aspect 3, wherein the body part of the virtual representation of the user comprises a humanoid component.

Aspect 5. The method of any one of Aspects 1 to 4, wherein the segment of the data associated with the child node includes interactivity information.

Aspect 6. The method of any one of Aspects 1 to 5, wherein the first node comprises a root node for the hierarchical set of nodes.

Aspect 7. The method of any one of Aspects 1 to 6, wherein the type information comprises a universal resource name indicating the format for the virtual representation of the user.

Aspect 8. The method of any one of Aspects 1 to 7, wherein the generated segment of the virtual representation of the user comprises mesh information.

Aspect 9. The method of Aspect 8, further comprising processing the mesh information to render a segment of the virtual representation of the user.

Aspect 10. The method of any one of Aspects 1 to 9, wherein the data comprises one or more data streams, and wherein the one or more data streams may vary based on the format for the virtual representation of the user.

Aspect 11. An apparatus for generating a virtual representation of a user, comprising: at least one memory; and at least one processor coupled to the at least one memory and configured to: receive data describing a virtual representation of the user, the data including a hierarchical set of nodes, wherein a first node of the set of nodes includes type information, source information, a mapping, or a combination thereof, and wherein a child node of the hierarchical set of nodes includes data associated with a segment of the virtual representation of the user; identify, based on the type information, a format associated with the virtual representation of the user; identify, based on the mapping, the child node in the hierarchical set of nodes; identify, based on the source information, a segment of the data associated with the child node; and process the data associated with the segment of the data associated with the child node based on a corresponding format for the virtual representation of the user to generate a segment of the virtual representation of the user.

Aspect 12. The apparatus of Aspect 11, wherein a sub-node of the child node includes data associated with a sub-segment of the segment of the virtual representation of the user.

Aspect 13. The apparatus of any one of Aspects 11 or 12, wherein the segment of the virtual representation of the user comprises a body part of the virtual representation of the user.

Aspect 14. The apparatus of Aspect 13, wherein the body part of the virtual representation of the user comprises a humanoid component.

Aspect 15. The apparatus of any one of Aspects 11 to 14, wherein the segment of the data associated with the child node includes interactivity information.

Aspect 16. The apparatus of any one of Aspects 11 to 15, wherein the first node comprises a root node for the hierarchical set of nodes.

Aspect 17. The apparatus of any one of Aspects 11 to 16, wherein the type information comprises a universal resource name indicating the format for the virtual representation of the user.

Aspect 18. The apparatus of any one of Aspects 11 to 17, wherein the generated segment of the virtual representation of the user comprises mesh information.

Aspect 19. The apparatus of Aspect 18, wherein the at least one processor is further configured to process the mesh information to render a segment of the virtual representation of the user.

Aspect 20. The apparatus of any one of Aspects 11 to 19, wherein the data comprises one or more data streams, and wherein the one or more data streams may vary based on the format for the virtual representation of the user.

Aspect 21. A non-transitory computer-readable medium having stored thereon instructions that, when executed by at least one processor, cause the at least one processor to: receive data describing a virtual representation of a user, the data including a hierarchical set of nodes, wherein a first node of the set of nodes includes type information, source information, a mapping, or a combination thereof, and wherein a child node of the hierarchical set of nodes includes data associated with a segment of the virtual representation of the user; identify, based on the type information, a format associated with the virtual representation of the user; identify, based on the mapping, the child node in the hierarchical set of nodes; identify, based on the source information, a segment of the data associated with the child node; and process the data associated with the segment of the data associated with the child node based on a corresponding format for the virtual representation of the user to generate a segment of the virtual representation of the user.

Aspect 22. The non-transitory computer-readable medium of Aspect 21, wherein a sub-node of the child node includes data associated with a sub-segment of the segment of the virtual representation of the user.

Aspect 23. The non-transitory computer-readable medium of any one of Aspects 21 or 22, wherein the segment of the virtual representation of the user comprises a body part of the virtual representation of the user.

Aspect 24. The non-transitory computer-readable medium of Aspect 23, wherein the body part of the virtual representation of the user comprises a humanoid component.

Aspect 25. The non-transitory computer-readable medium of any one of Aspects 21 to 24, wherein the segment of the data associated with the child node includes interactivity information.

Aspect 26. The non-transitory computer-readable medium of any one of Aspects 21 to 25, wherein the first node comprises a root node for the hierarchical set of nodes.

Aspect 27. The non-transitory computer-readable medium of any one of Aspects 21 to 26, wherein the type information comprises a universal resource name indicating the format for the virtual representation of the user.

Aspect 28. The non-transitory computer-readable medium of any one of Aspects 21 to 27, wherein the generated segment of the virtual representation of the user comprises mesh information.

Aspect 29. The non-transitory computer-readable medium of Aspect 28, wherein the instructions cause the at least one processor to process the mesh information to render a segment of the virtual representation of the user.

Aspect 30. The non-transitory computer-readable medium of any one of Aspects 21 to 29, wherein the data comprises one or more data streams, and wherein the one or more data streams may vary based on the format for the virtual representation of the user.

Aspect 31. An apparatus for generating a virtual representation of a user, the apparatus including one or more means for performing operations according to any of Aspects 1 to 10.

Aspect 41. A method for generating a virtual representation of a user, comprising: obtaining information describing a virtual representation of the user, the information including a hierarchical set of nodes, wherein a first node of the hierarchical set of nodes comprises a root node for the hierarchical set of nodes, wherein the first node includes a mapping configuration for mapping child nodes of the hierarchical set of nodes to segments of the virtual representation of the user, and wherein a child node of the hierarchical set of nodes includes data associated with a segment of the virtual representation of the user; identifying a portion of the data associated with the child node; and processing the portion of the data associated with the child node to generate the segment of the virtual representation of the user.

Aspect 42. The method of Aspect 41, wherein the segment includes at least one body part of the virtual representation of the user.

Aspect 43. The method of Aspect 42, wherein the at least one body part of the virtual representation of the user comprises a humanoid component.

Aspect 44. The method of any of Aspects 41-43, wherein the first node includes type information, and further wherein the portion of the data associated with the child node is processed based on the type information.

Aspect 45. The method of Aspect 44, wherein the type information comprises information indication how the virtual representation of the user is represented.

Aspect 46. The method of any of Aspects 44-45, wherein the type information comprises a universal resource name indicating a format for the virtual representation of the user.

Aspect 47. The method of Aspect 46, wherein processing the portion of the data associated with the child node comprises processing the portion of the data associated with the child node based on the indicated format for the virtual representation of the user.

Aspect 48. The method of any of Aspects 41-47, wherein the first node includes source information, and wherein the portion of the data associated with the child node is identified based on source information.

Aspect 49. The method of any of Aspects 41-48, wherein a sub-node of the child node includes data associated with a sub-segment of the segment of the virtual representation of the user.

Aspect 50. The method of any of Aspects 41-49, wherein the portion of the data associated with the child node includes interactivity information indicating whether the segment of the virtual representation of the user can interact with other objects.

Aspect 51. The method of any of Aspects 41-50, wherein the generated segment of the virtual representation of the user comprises mesh information.

Aspect 52. The method of Aspect 51, further comprising processing the mesh information to render the generated segment of the virtual representation of the user.

Aspect 53. The method of any of Aspects 41-52, wherein the data comprises one or more data streams, and wherein the one or more data streams is based on a format for the virtual representation of the user.

Aspect 54. An apparatus for generating a virtual representation of a user, comprising: at least one memory; and at least one processor coupled to the at least one memory and configured to: obtain information describing a virtual representation of the user, the information including a hierarchical set of nodes, wherein a first node of the hierarchical set of nodes comprises a root node for the hierarchical set of nodes, wherein the first node includes a mapping configuration for mapping child nodes of the hierarchical set of nodes to segments of the virtual representation of the user, and wherein a child node of the hierarchical set of nodes includes data associated with a segment of the virtual representation of the user; identify a portion of the data associated with the child node; and process the portion of the data associated with the child node to generate the segment of the virtual representation of the user.

Aspect 55. The apparatus of Aspect 54, wherein the segment includes at least one body part of the virtual representation of the user.

Aspect 56. The apparatus of Aspect 55, wherein the at least one body part of the virtual representation of the user comprises a humanoid component.

Aspect 57. The apparatus of any of Aspects 54-56, wherein the first node includes type information, and further wherein the portion of the data associated with the child node is processed based on the type information.

Aspect 58. The apparatus of Aspect 57, wherein the type information comprises information indication how the virtual representation of the user is represented.

Aspect 59. The apparatus of any of Aspects 57-58, wherein the type information comprises a universal resource name indicating a format for the virtual representation of the user.

Aspect 60. The apparatus of Aspect 59, wherein, to process the portion of the data associated with the child node, the at least one processor is configured to process the portion of the data associated with the child node based on the indicated format for the virtual representation of the user.

Aspect 61. The apparatus of any of Aspects 54-60, wherein the first node includes source information, and wherein the portion of the data associated with the child node is identified based on source information.

Aspect 62. The apparatus of any of Aspects 54-61, wherein a sub-node of the child node includes data associated with a sub-segment of the segment of the virtual representation of the user.

Aspect 63. The apparatus of any of Aspects 54-62, wherein the portion of the data associated with the child node includes interactivity information indicating whether the segment of the virtual representation of the user can interact with other objects.

Aspect 64. The apparatus of any of Aspects 54-63, wherein the generated segment of the virtual representation of the user comprises mesh information.

Aspect 65. The apparatus of Aspect 64, wherein the at least one processor is further configured to process the mesh information to render the generated segment of the virtual representation of the user.

Aspect 66. The apparatus of Aspect 64-68, wherein the data comprises one or more data streams, and wherein the one or more data streams is based on a format for the virtual representation of the user.

Aspect 67. A non-transitory computer-readable medium having stored thereon instructions that, when executed by at least one processor, cause the at least one processor to: obtain information describing a virtual representation of a user, the information including a hierarchical set of nodes, wherein a first node of the hierarchical set of nodes comprises a root node for the hierarchical set of nodes, wherein the first node includes a mapping configuration for mapping child nodes of the hierarchical set of nodes to segments of the virtual representation of the user, and wherein a child node of the hierarchical set of nodes includes data associated with a segment of the virtual representation of the user; identify a portion of the data associated with the child node; and process the portion of the data associated with the child node to generate the segment of the virtual representation of the user.

Aspect 68. The non-transitory computer-readable medium of Aspect 67, wherein the segment includes at least one body part of the virtual representation of the user.

Aspect 69. The non-transitory computer-readable medium of Aspect 68, wherein the at least one body part of the virtual representation of the user comprises a humanoid component.

Aspect 70. The non-transitory computer-readable medium of Aspect 67-69, wherein the first node includes type information, and further wherein the portion of the data associated with the child node is processed based on the type information.

Aspect 71. The non-transitory computer-readable medium of Aspect 70, wherein the type information comprises information indication how the virtual representation of the user is represented.

Aspect 72. The non-transitory computer-readable medium of any of Aspects 70-71, wherein the type information comprises a universal resource name indicating a format for the virtual representation of the user.

Aspect 73. The non-transitory computer-readable medium of Aspect 72, wherein, to process the portion of the data associated with the child node, the instructions cause the at least one processor to process the portion of the data associated with the child node based on the indicated format for the virtual representation of the user.

Aspect 74. The non-transitory computer-readable medium of any of Aspects 67-73, wherein the first node includes source information, and wherein the portion of the data associated with the child node is identified based on source information.

Aspect 75. The non-transitory computer-readable medium of any of Aspects 67-74, wherein a sub-node of the child node includes data associated with a sub-segment of the segment of the virtual representation of the user.

Aspect 76. The non-transitory computer-readable medium of any of Aspects 67-75, wherein the portion of the data associated with the child node includes interactivity information indicating whether the segment of the virtual representation of the user can interact with other objects.

Aspect 77. The non-transitory computer-readable medium of any of Aspects 67-76, wherein the generated segment of the virtual representation of the user comprises mesh information.

Aspect 78. The non-transitory computer-readable medium of any of Aspects 67-77, wherein the instructions cause the at least one processor to process the mesh information to render the generated segment of the virtual representation of the user.

Aspect 79. The non-transitory computer-readable medium of any of Aspects 67-78, wherein the data comprises one or more data streams, and wherein the one or more data streams is based on a format for the virtual representation of the user.

Aspect 80. An apparatus for generating a virtual representation of a user, the apparatus including one or more means for performing operations according to any of Aspects 41-53.

What is claimed is:

1. A method for generating a virtual representation of a user, comprising:
obtaining information describing a virtual representation of the user, the information including a hierarchical set of nodes, wherein a first node of the hierarchical set of nodes comprises a root node for the hierarchical set of nodes, wherein the first node includes a mapping configuration for mapping child nodes of the hierarchical set of nodes to segments of the virtual representation of the user, and wherein a child node of the hierarchical set of nodes includes data associated with a segment of the virtual representation of the user;
identifying a portion of the data associated with the child node; and
processing the portion of the data associated with the child node to generate the segment of the virtual representation of the user.

2. The method of claim 1, wherein the segment includes at least one body part of the virtual representation of the user.

3. The method of claim 2, wherein the at least one body part of the virtual representation of the user comprises a humanoid component.

4. The method of claim 1, wherein the first node includes type information, and further wherein the portion of the data associated with the child node is processed based on the type information.

5. The method of claim 4, wherein the type information comprises information indication how the virtual representation of the user is represented.

6. The method of claim 4, wherein the type information comprises a universal resource name indicating a format for the virtual representation of the user.

7. The method of claim 6, wherein processing the portion of the data associated with the child node comprises processing the portion of the data associated with the child node based on the indicated format for the virtual representation of the user.

8. The method of claim 1, wherein the first node includes source information, and wherein the portion of the data associated with the child node is identified based on source information.

9. The method of claim 1, wherein a sub-node of the child node includes data associated with a sub-segment of the segment of the virtual representation of the user.

10. The method of claim 1, wherein the portion of the data associated with the child node includes interactivity information indicating whether the segment of the virtual representation of the user can interact with other objects.

11. The method of claim 1, wherein the generated segment of the virtual representation of the user comprises mesh information.

12. The method of claim 11, further comprising processing the mesh information to render the generated segment of the virtual representation of the user.

13. The method of claim 1, wherein the data comprises one or more data streams, and wherein the one or more data streams is based on a format for the virtual representation of the user.

14. An apparatus for generating a virtual representation of a user, comprising:
at least one memory; and
at least one processor coupled to the at least one memory and configured to:
obtain information describing a virtual representation of the user, the information including a hierarchical set of nodes, wherein a first node of the hierarchical set of nodes comprises a root node for the hierarchical set of nodes, wherein the first node includes a mapping configuration for mapping child nodes of the hierarchical set of nodes to segments of the virtual representation of the user, and wherein a child node of the hierarchical set of nodes includes data associated with a segment of the virtual representation of the user;
identify a portion of the data associated with the child node; and
process the portion of the data associated with the child node to generate the segment of the virtual representation of the user.

15. The apparatus of claim 14, wherein the segment includes at least one body part of the virtual representation of the user.

16. The apparatus of claim 15, wherein the at least one body part of the virtual representation of the user comprises a humanoid component.

17. The apparatus of claim 14, wherein the first node includes type information, and further wherein the portion of the data associated with the child node is processed based on the type information.

18. The apparatus of claim 17, wherein the type information comprises information indication how the virtual representation of the user is represented.

19. The apparatus of claim 17, wherein the type information comprises a universal resource name indicating a format for the virtual representation of the user.

20. The apparatus of claim 19, wherein, to process the portion of the data associated with the child node, the at least one processor is configured to process the portion of the data associated with the child node based on the indicated format for the virtual representation of the user.

21. The apparatus of claim 14, wherein the first node includes source information, and wherein the portion of the data associated with the child node is identified based on source information.

22. The apparatus of claim 14, wherein a sub-node of the child node includes data associated with a sub-segment of the segment of the virtual representation of the user.

23. The apparatus of claim 14, wherein the portion of the data associated with the child node includes interactivity information indicating whether the segment of the virtual representation of the user can interact with other objects.

24. The apparatus of claim 14, wherein the generated segment of the virtual representation of the user comprises mesh information.

25. The apparatus of claim 24, wherein the at least one processor is further configured to process the mesh information to render the generated segment of the virtual representation of the user.

26. The apparatus of claim 14, wherein the data comprises one or more data streams, and wherein the one or more data streams is based on a format for the virtual representation of the user.

27. A non-transitory computer-readable medium having stored thereon instructions that, when executed by at least one processor, cause the at least one processor to:
obtain information describing a virtual representation of a user, the information including a hierarchical set of nodes, wherein a first node of the hierarchical set of nodes comprises a root node for the hierarchical set of nodes, wherein the first node includes a mapping configuration for mapping child nodes of the hierarchical set of nodes to segments of the virtual representation of the user, and wherein a child node of the hierarchical set of nodes includes data associated with a segment of the virtual representation of the user;
identify a portion of the data associated with the child node; and
process the portion of the data associated with the child node to generate the segment of the virtual representation of the user.

28. The non-transitory computer-readable medium of claim 27, wherein the segment includes at least one body part of the virtual representation of the user.

29. The non-transitory computer-readable medium of claim 28, wherein the at least one body part of the virtual representation of the user comprises a humanoid component.

30. The non-transitory computer-readable medium of claim 27, wherein the first node includes type information, and further wherein the portion of the data associated with the child node is processed based on the type information.

31. The non-transitory computer-readable medium of claim 30, wherein the type information comprises information indication how the virtual representation of the user is represented.

32. The non-transitory computer-readable medium of claim 30, wherein the type information comprises a universal resource name indicating a format for the virtual representation of the user.

33. The non-transitory computer-readable medium of claim 32, wherein, to process the portion of the data associated with the child node, the instructions cause the at least one processor to process the portion of the data associated with the child node based on the indicated format for the virtual representation of the user.

34. The non-transitory computer-readable medium of claim 27, wherein the first node includes source information, and wherein the portion of the data associated with the child node is identified based on source information.

35. The non-transitory computer-readable medium of claim 27, wherein a sub-node of the child node includes data associated with a sub-segment of the segment of the virtual representation of the user.

36. The non-transitory computer-readable medium of claim 27, wherein the portion of the data associated with the child node includes interactivity information indicating whether the segment of the virtual representation of the user can interact with other objects.

37. The non-transitory computer-readable medium of claim 27, wherein the generated segment of the virtual representation of the user comprises mesh information.

38. The non-transitory computer-readable medium of claim 37, wherein the instructions cause the at least one processor to process the mesh information to render the generated segment of the virtual representation of the user.

39. The non-transitory computer-readable medium of claim 27, wherein the data comprises one or more data streams, and wherein the one or more data streams is based on a format for the virtual representation of the user.
